(19) United States
(12) Patent Application Publication
(10) Pub. No.: US 2009/0289886 A1
(43) Pub. Date: Nov. 26, 2009

(54) DISPLAY PANEL DRIVING CIRCUIT AND DISPLAY APPARATUS

(76) Inventors: Tamotsu Sakai, Nara (JP); Shinsaku Shimizu, Jiangsu Province (CN)

Correspondence Address: BIRCH STEWART KOLASCH & BIRCH, PO BOX 747, FALLS CHURCH, VA, 22040-0747, US

(21) Appl. No.: 12/296,448

(22) PCT Filed: Feb. 19, 2007
(86) PCT No.: PCT/JP2007/052986

§ 371 Date: Oct. 8, 2008

(30) Foreign Application Priority Data
May 24, 2006 (JP) 2006-144716

(51) Int. Cl. G09G 3/36

(52) U.S. Cl. 345/98

(57) ABSTRACT

A display panel driving circuit includes a plurality of circuit blocks g aligned in a row direction, in each of which an upstream circuit and a downstream circuit are included and signal transmission is carried out between the upstream circuit and the downstream circuit that belong to one and the same circuit block. In each of the plurality of circuit blocks, the upstream circuit and the downstream circuit are aligned in the column direction. A inter-block common wiring Q is provided for every two circuit blocks. Signal transmission in one (g1) of the two circuit blocks and signal transmission in the other (g2) of the two circuit blocks are carried out with the inter-block common wiring Q1 at respective timings that are different from each other. Without an external memory or an operational circuit, this allows the area of the display panel driving circuit (driver) to be reduced.

### TECHNICAL FIELD

The present invention relates to a source driver (especially to a digital driver) to be provided in a display apparatus.

### BACKGROUND ART

Patent Document 1 discloses one arrangement of a digital driver to be provided in a display apparatus. FIG. 17 illustrates the arrangement. The digital driver illustrated in FIG. 17 includes, for every data signal line (S1 . . . ) of a display panel, a circuit block having a plurality of first latch circuits LAT1 and a plurality of second latch circuits LAT2.

In the arrangement, in response to a pulse transmitted from a DFF of a shift register (i.e., in response to a first latch pulse), each circuit block takes in, from D0 to D2, 3-bit data to be supplied to the data signal line (S1, S2, . . . ) that the circuit block corresponds. Then, in response to a pulse transmitted to an LP line (in response to a second latch pulse), the 3-bit data is DA converted and outputted as an analog signal potential to the data signal line (S1, S2, . . . ) that the circuit block corresponds.

Patent Document 1 also discloses another arrangement of a digital driver. FIG. 18. illustrates the another arrangement. The digital driver illustrated in FIG. 18 includes, for every four data signal lines (S1˜S4, S5˜S8, . . . ) of a display panel, a circuit block having a plurality of first latch circuits LAT1 and a plurality of second latch circuits LAT2.

In the arrangement, one horizontal period is divided into four (the first through the fourth periods), so that one circuit block is shared among four data signal lines.

That is, in the first period, in response to a pulse transmitted from a DFF of a shift register (i.e., in response to a first latch pulse), each circuit block takes in, from D0 to D2, 3-bit data to be supplied to a corresponding data signal line (S1, S5, . . . ). Then, in response to pulses transmitted to lines LPa and LPb (i.e., in response to second latch pulses), the 3-bit data is DA converted and outputted as an analog signal potential to the corresponding data signal line (S1, S5, . . . ). In the following second period, in response to a pulse transmitted from the DFF of the shift register (i.e., in response to the first latch pulse), each circuit block takes in, from D0 to D2, 3-bit data to be supplied to a corresponding data signal line (S2, S6, . . . ). Then, in response to pulses transmitted from the lines LPa and LPb (i.e., in response to the second latch pulses), the 3-bit data is DA converted and outputted as an analog signal potential to the corresponding data signal line (S2, S6 . . . ). This is repeated until the fourth period.

[Patent Document 1] Japanese Unexamined Patent Publication 2003-58133 (Tokukai 2003-58133 (published on Feb. 28, 2003))

### DISCLOSURE OF INVENTION

An arrangement illustrated in FIG. 17 requires (i) first latch circuits (LAT1) as many as the product of the number of data signal lines (the number of circuit blocks) multiplied by the number of bits of data and (ii) second latch circuits (LAT2) as many as the first latch circuits. This accordingly increases the number of wirings for connecting the first latch circuits and the second latch circuits, thereby causing a problem that the size of a driver increases. Especially, in a case where a driver and a display panel are monolithically formed, it is difficult to give wirings a multilayer structure. Accordingly, an increase in the number of wirings greatly affects the size of the driver. FIG. 19 illustrates one example of circuit layout of the digital driver. As illustrated in FIG. 19, in a case where 6 bits are allocated to each of R, G, and B of an input signal, it is necessary to provide between circuit blocks 18 wirings for connecting a first latch circuit and a second latch circuit. Accordingly, the breadth of the driver becomes wide. If the longer side of a first latch circuit is longitudinally oriented so that the breadth can be reduced (i.e., the first latch circuits are longitudinally aligned), the length of the driver becomes long.

According to the arrangement illustrated in FIG. 18, sorting of data is necessary for dividing a horizontal period into four whereas the number of circuit blocks can be reduced. This leads to a problem that an external memory and an operational circuit for the sorting need to be provided.

In view of the problems, an object of the present invention is to realize miniaturization of a driver (a display panel driving circuit) without an external memory and an operational circuit.

A display panel driving circuit of the present invention includes a plurality of circuit blocks aligned in a row direction, each circuit block including an upstream circuit and a downstream circuit, wherein in each circuit block, a signal is transmitted from the upstream circuit to the downstream circuit, wherein: in each circuit block, the upstream circuit and the downstream circuit are aligned in a column direction; between the circuit blocks adjacently paired, an inter-block common wiring that is connectable to the circuit blocks adjacently paired is provided; and the signals from the circuit blocks adjacently paired are transmitted in a time-division manner via the inter-block common wiring. In other words, the display panel driving circuit includes a plurality of circuit blocks aligned in a row direction, each circuit block including an upstream circuit and a downstream circuit, wherein signal transmission is carried out between the upstream circuit and the downstream circuit that belong to the same circuit block, wherein: in each of the plurality of circuit blocks, a plurality of upstream circuits and a plurality of downstream circuits are aligned in a column direction; an inter-block common wiring is provided for every two circuit blocks; and signal transmission in one of the two circuit blocks and signal transmission in the other of the two circuit blocks are carried out via the inter-block common wiring at respective timings that are different from each other. Note that the row direction is a direction in which a row is extended (i.e., a lateral direction) and the column direction is a direction in which a column is extended (i.e., a longitudinal direction).

As described above, two adjacent circuit blocks perform signal transmission in a time-division manner, thereby sharing a wiring for the signal transmission. This allows the number of wirings in the display panel driving circuit to be reduced. This realizes miniaturization of the display panel driving circuit.

The display panel driving circuit may be arranged such that: the upstream circuit includes a plurality of upstream latch circuits aligned in the column direction; the downstream circuit includes a plurality of downstream latch circuits respectively corresponding to the plurality of upstream latch circuits; the inter-block common wiring includes a plurality of transmission wirings extended in the column direction; and the upstream latch circuits, which belong respectively to the circuit blocks adjacently paired and are adjacently paired in the row direction, transmit the signal in the time-divisional manner via the same one of the plurality of transmission wirings. This is an arrangement suitable for a digital driver.

The display panel driving circuit may be arranged such that: an output wiring extended in the row direction is provided between the upstream latch circuits adjacently paired in the row direction, the output wiring is connected to the transmission wiring and the transmission wiring is connectable, via the output wiring, with an output terminal of each of the upstream latch circuits adjacently paired in the row direction. This makes it possible to simplify a relation of connections (i.e., wirings extended in the row direction) between two adjacent circuit blocks.

The display panel driving circuit may be arranged such that: a plurality of data wirings extended in the column direction is provided between the circuit blocks adjacently paired; and input terminals of the upstream latch circuits adjacently paired in the row direction are connected with each other via an input wiring extended in the row direction and the input wiring is connected with one of the plurality of data wirings. This makes it possible to simplify a relation of connections (i.e., wirings extended in the row direction) between two adjacent circuit blocks.

The display panel driving circuit may be arranged such that: the plurality of data wirings is provided as many as the plurality of transmission wirings and each of the plurality of data wirings is extended to corresponding one of the plurality of transmission wiring. This makes it possible to reduce the size of the row direction of the display panel driving circuit.

The display panel driving circuit may be arranged such that: each of the plurality of the upstream latch circuit is greater in size in the row direction than in the column direction. This makes it possible to reduce the size of the column direction of the display panel driving circuit.

The display panel driving circuit may be arranged such that: high-potential-side power wirings extended in the row direction and low-potential-side power wirings extended in the row direction are provided alternately; and each of the plurality of upstream latch circuits is provided respectively between the high-potential-side power wiring and the low-potential-side power wiring that are adjacent to each other. In this case, The display panel driving circuit may be arranged such that: in each of the circuit blocks, upstream latch circuits adjacently paired in the column direction are provided so that a structure of one of the upstream latch circuits and a structure of the other one of the upstream latch circuits are axisymmetrical with each other with respect to a line running in the row direction; one high-potential-side power wiring is shared between the upstream latch circuits adjacently paired and one low-potential-side power wiring is shared between the two upstream latch circuits adjacently paired. This makes it possible to reduce the number of power wirings, thereby realizing a reduction in the size of the column direction of the display panel driving a circuit.

The display panel driving circuit may be arranged such that: video data of one pixel of a display panel is transmitted from the upstream circuit to the downstream circuit; and the plurality of transmission wirings is equal in number to a total number of bits of the video data of the one pixel.

A display panel driving circuit includes a plurality of circuit blocks aligned in a row direction, each circuit block including a plurality of upstream signal circuits and a plurality of downstream signal circuits respectively corresponding to the plurality of upstream signal circuits, wherein in each circuit block, a signal is transmitted from each upstream signal circuit to the corresponding downstream signal circuit, wherein: in each of the plurality of circuit blocks, the plurality of upstream signal circuits are aligned in a column direction; in each of the plurality of circuit blocks, an in-block common wiring is provided, to which all of the plurality of upstream signal circuits of the circuit block are connectable; and the signal from each of the plurality of upstream signal circuits is transmitted in a time-division manner via the in-block common wiring.

As described above, signal transmission is performed in a time-division manner in each circuit block, thereby sharing a wiring for the signal transmission. This allows the number of wirings in the display panel driving circuit to be reduced. This realizes miniaturization of the display panel driving circuit.

The display panel driving circuit may be arranged such that: each of the plurality of upstream signal circuits includes a plurality of upstream latch circuits aligned in the column direction; each of the plurality of downstream signal circuits includes a plurality of downstream latch circuits respectively corresponding to the plurality of upstream latch circuits; the in-block common wiring includes a plurality of transmission wirings extended in the column direction; and each of the plurality of transmission wirings is connectable respectively to one of the plurality of upstream latch circuits included in each of the plurality of upstream signal circuits.

The display panel driving circuit may be arranged such that: an output wiring extended in the row direction is provided for each of the plurality of upstream latch circuits; and an output terminal of each of the plurality of upstream latch circuits is connectable to the corresponding one of the plurality of transmission wirings via the corresponding one of the plurality of output wirings.

The display panel driving circuit may be arranged such that: a plurality of data wirings extended in the row direction is provided; and each of the plurality of upstream latch circuits is connected respectively to one of the plurality of data wirings. The display panel driving circuit may be arranged such that: high-potential-side power wirings extended in the row direction and low-potential-side power wirings extended in the row direction are alternately provided; and each of the plurality of upstream latch circuits is provided respectively between the high-potential-side power wiring and the low-potential-side power wiring that are adjacent to each other.

The display panel driving circuit may be arranged such that: in each of the plurality of circuit blocks, upstream latch circuits adjacently paired in the column direction are provided so that a structure of one of the upstream latch circuits and a structure of the other one of the upstream latch circuits are axisymmetrical with each other with respect to a line running in the row direction; one high-potential-side power wiring is shared between the upstream latch circuits adjacently paired; and the low-potential-side power wiring is shared between the upstream latch circuits adjacently paired.

The display panel driving circuit may be arranged such that the upstream latch circuit is greater in size in the row direction than in the column direction.

The display panel driving circuit may be arranged such that: video data of one sub-pixel of a display panel is transmitted from each upstream signal circuit to the corresponding downstream signal circuit; and the plurality of transmission wirings is equal in number to a total number of bits of the video data of the one sub-pixel.

A display panel driving circuit of the present invention includes a plurality of circuit blocks aligned in a row direction, each circuit block including a plurality of upstream signal circuits, and a plurality of downstream signal circuits respectively corresponding to the plurality of upstream signal circuits, and one signal relay circuit, wherein a signal is transmitted from each downstream signal circuit to the signal relay circuit, wherein: in each of the plurality of circuit blocks, the plurality of downstream signal circuits is aligned in a column direction; each of the plurality of circuit blocks includes a universally-shared common wiring to which all the downstream signal circuits of the circuit block are connectable; and the signal from each of the plurality of downstream signal circuits is transmitted in a time-division manner via the universally-shared common wiring.

The display panel driving circuit may be arranged such that, in each of the plurality of circuit blocks, each upstream signal circuit and the corresponding downstream signal are aligned adjacently to each other in the row direction and connected to each other.

The display panel driving circuit may be arranged such that: each of the plurality of upstream signal circuits includes a plurality of upstream latch circuits aligned in the column direction; each of the plurality of downstream signal circuits includes a plurality of downstream latch circuits respectively corresponding to the plurality of upstream latch circuits; the universally-shared common wiring includes a plurality of relay wirings extended in the column direction; and each of the plurality of relay wirings is connectable respectively to one of the plurality of downstream latch circuits included in each of the plurality of downstream signal circuits.

The display panel driving circuit may be arranged such that: an output wiring extended in the row direction is provided for each of the plurality of downstream latch circuits; and an output terminal of each of the plurality of downstream latch circuits is connectable to the corresponding one of the plurality of relay wirings via the corresponding one of the plurality of output wirings.

The display panel driving circuit may be arranged such that: a plurality of data wirings extended in the row direction is provided; and each of the plurality of upstream latch circuits is respectively connected to one of the plurality of data wirings.

The display panel driving circuit may be arranged such that: high-potential-side power wirings extended in the row direction and low-potential-side power wirings extended in the row direction are alternately provided; each upstream latch circuit and the corresponding downstream latch circuit are aligned adjacently to each other in the row direction and connected to each other; and each upstream latch circuit and the corresponding downstream latch circuit are provided respectively between the high-potential-side power wiring and the low-potential-side power wiring that are adjacent to each other. In this case, each of the plurality of upstream latch circuits and each of the plurality of downstream latch circuits may be greater in size in the column direction than in the row direction.

A display apparatus of the present invention includes: the display panel driving circuit; and a display panel driven by the display panel driving circuit. In this case, the display panel and the display panel driving circuit may be monolithically formed.

As described above, in the display panel driving circuit of the present invention, two adjacent circuit blocks perform signal transmission in a time-division manner, thereby sharing a wiring for the signal transmission. This allows the number of wirings in the display panel driving circuit to be reduced. As a result, this realizes miniaturization of the display panel driving circuit.

### BRIEF DESCRIPTION OF DRAWINGS

FIG. 1 is a circuit diagram illustrating a layout example of a digital driver of a present embodiment.

FIG. 2 is a circuit diagram illustrating a layout example of the digital driver.

FIG. 3 is a circuit diagram illustrating a layout example of the digital driver.

FIG. 4 is a circuit diagram illustrating a layout example of the digital driver.

FIG. 5 is a circuit diagram illustrating a layout example of the digital driver.

FIG. 6 is a circuit diagram illustrating a layout example of the digital driver.

FIG. 7 is a circuit diagram illustrating an arrangement of the digital driver of the present embodiment.

FIG. 8 is a circuit diagram illustrating an arrangement of the digital driver of the present embodiment.

FIG. 9 is a circuit diagram illustrating a concrete arrangement of a part of the digital driver illustrated in FIG. 7.

FIG. 10 is a circuit diagram illustrating a concrete arrangement of a part of the digital driver illustrated in FIG. 7.

FIG. 11 is a circuit diagram illustrating another arrangement of the digital driver of the present embodiment.

FIG. 12 is a circuit diagram illustrating further another arrangement of the digital driver of the present embodiment.

FIG. 13 is a timing diagram illustrating an operation of the digital driver illustrated in FIG. 7.

FIG. 14 is a timing diagram illustrating an operation of the digital driver illustrated in FIG. 9.

FIG. 15 is a timing diagram illustrating an operation of the digital driver illustrated in FIG. 10.

FIG. 16 is a schematic view illustrating an arrangement of a liquid crystal display apparatus of the present embodiment.

FIG. 17 is a circuit diagram illustrating an arrangement of a conventional digital driver.

FIG. 18 is a circuit diagram illustrating an arrangement of the conventional digital driver.

FIG. 19 is a circuit diagram illustrating a layout example of the conventional digital driver.

### EXPLANATION OF REFERENCE LETTERS AND NUMERALS

10: Liquid crystal display apparatus (display apparatus)
30: Display section
40: Gate driver
60: Shift register
90: Source driver (display panel driving circuit)
g: Circuit block
BR•BG•BB: Upstream latch block (upstream signal circuit)
CR•CG•CB: Downstream latch block (downstream signal circuit)
LR: First latch circuit (upstream latch circuit)
Lr: Second latch circuit (downstream latch circuit)
Q: Inter-block common wiring
HR•HG•HB: Discriminatingly-shared common wiring
CL: Universally-shared common wiring
N: In-block common wiring
T: Transmission switching block
iR•iG•iB: Switching circuit (for switching transmission)
MR•MG•MB: Transmission switching line
Y1•Y2•Y: Latch pulse line

### BEST MODE FOR CARRYING OUT THE INVENTION

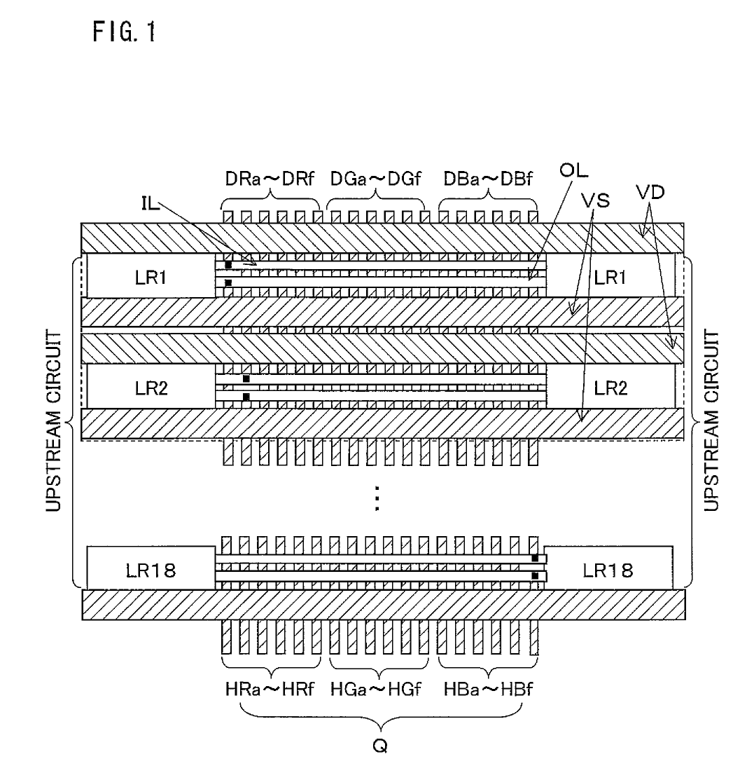

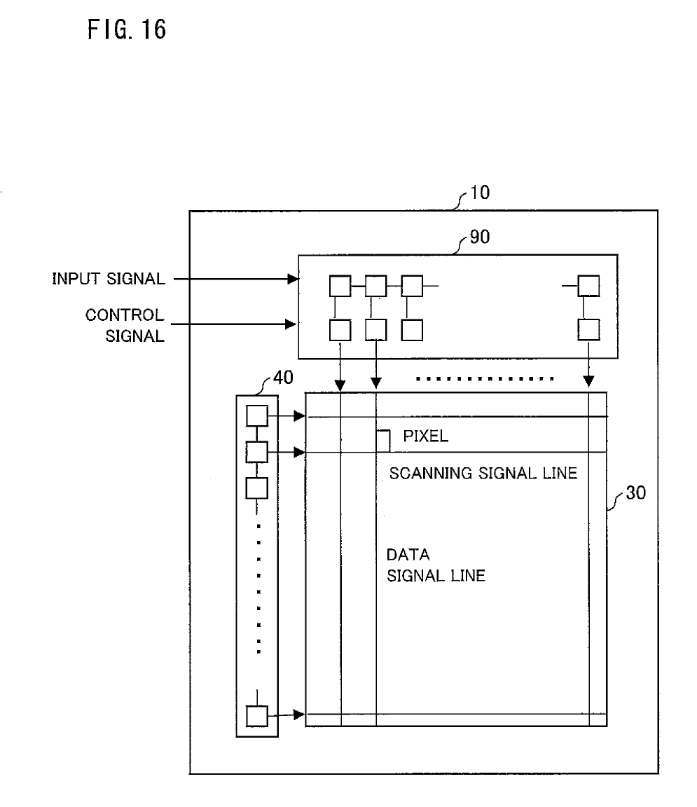

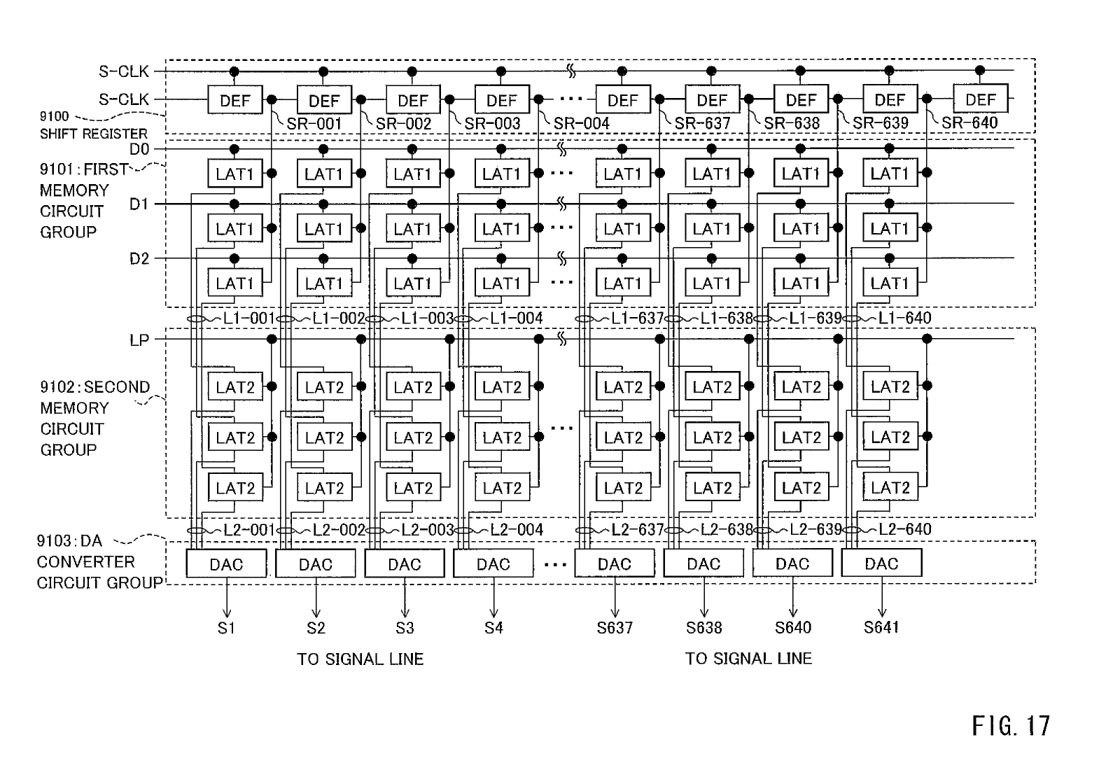

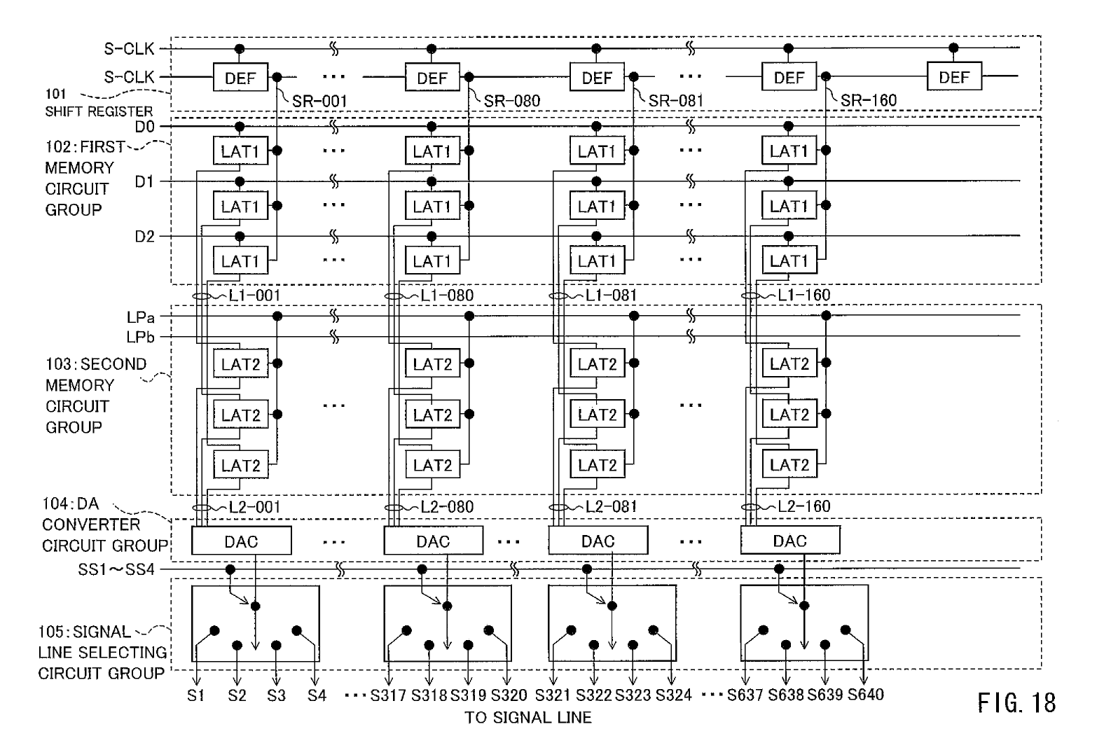

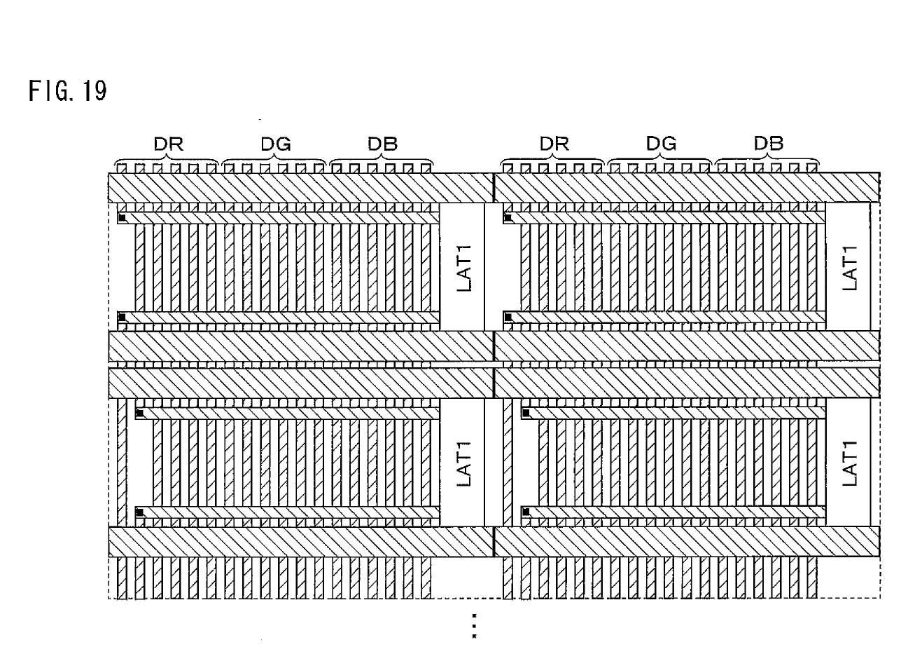

The following describes an embodiment of the present invention with reference to FIGS. 1 through 16. FIG. 16 is a block diagram illustrating an arrangement of a liquid crystal display apparatus of the present embodiment. As illustrated in FIG. 16, a liquid crystal display apparatus 10 includes a display section 30, a gate driver 40, and a source driver 90. The display section 30, the gate driver 40, and the source driver 90 are formed on the same substrate, thereby composing a so-called system-on-panel. An input signal (video data) and various control signals are supplied with the source driver 90. The display section 30 includes a pixel in the vicinity of each of intersection points of a plurality of scanning signal lines extended in a row direction and a plurality of data signal lines extended in a column direction.

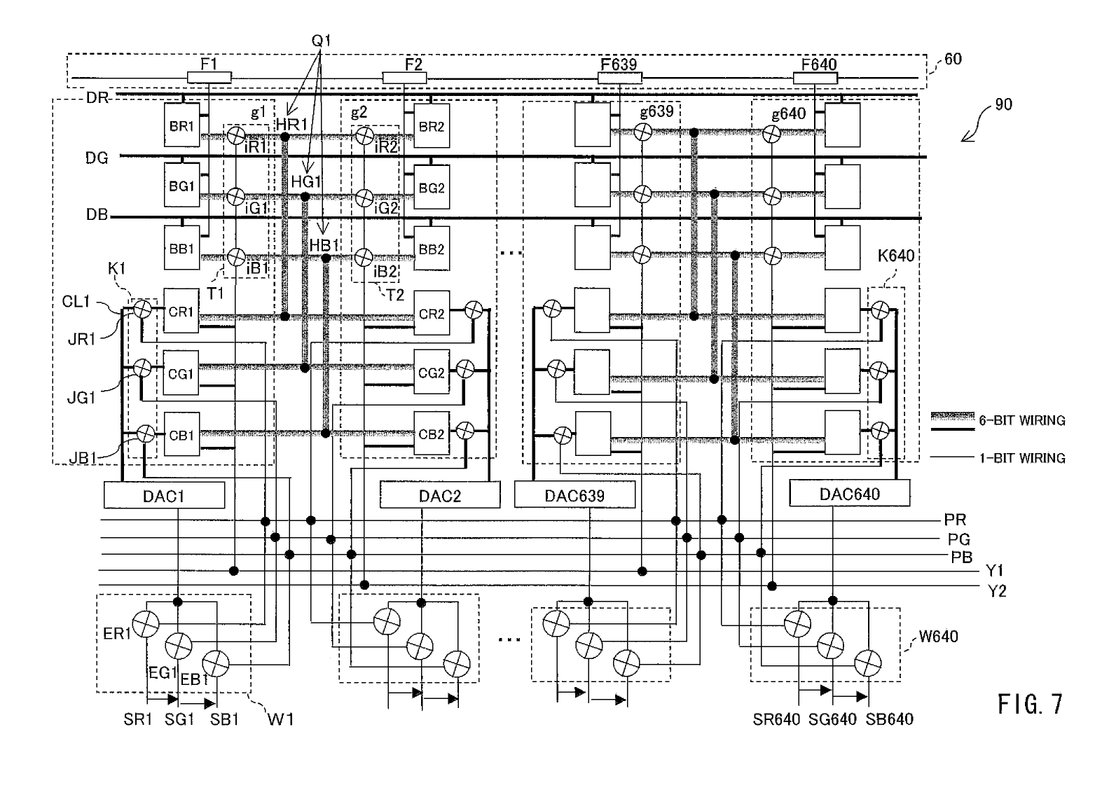

FIG. 7 is a circuit diagram illustrating an arrangement of the source driver of the liquid crystal display apparatus. The source driver 90 (hereinafter, referred to as a digital driver 90) is a digital driver that (i) generates an analog signal potential based on a digital input signal (for example, a 6-bit digital input signal) supplied from the outside of the panel and (ii) supplies the analog signal potential with each of the data signal lines of the display section.

As illustrated in FIG. 7, the digital driver 90 includes three input signal lines DR, DG, and DB, a plurality of signal processing blocks (not illustrated), three switch control lines PR, PG, and PB, and two latch pulse lines Y1 and Y2 (first and second control signal lines).

Each of the signal processing blocks includes one flip-flop F, one circuit block g, one DAC, and one time-division switch block W. Each of the signal processing blocks corresponds to three data signal lines SR, SG, and SB of the display section. Each of the time-division switch blocks W includes three analog switches ER, EG, and EB.

Each circuit block g includes three upstream latch blocks BR, BG, and BB, which are aligned in the column direction, three downstream latch blocks CR, CG, and CB, which are aligned in the column direction, one transmission switching block T, one selecting switch block K, and one universally-shared common wiring (6-bit) CL that is shared among signals. In the digital driver 90, a plurality of circuit blocks is aligned in the row direction. An inter-block common wiring Q is provided between two adjacent circuit blocks (for example, between the first and second circuit blocks and between the third and fourth circuit blocks). The inter-block common wiring Q includes three discriminatingly-shared common wirings HR, HG, and HB each of which is shared among signals of the same type.

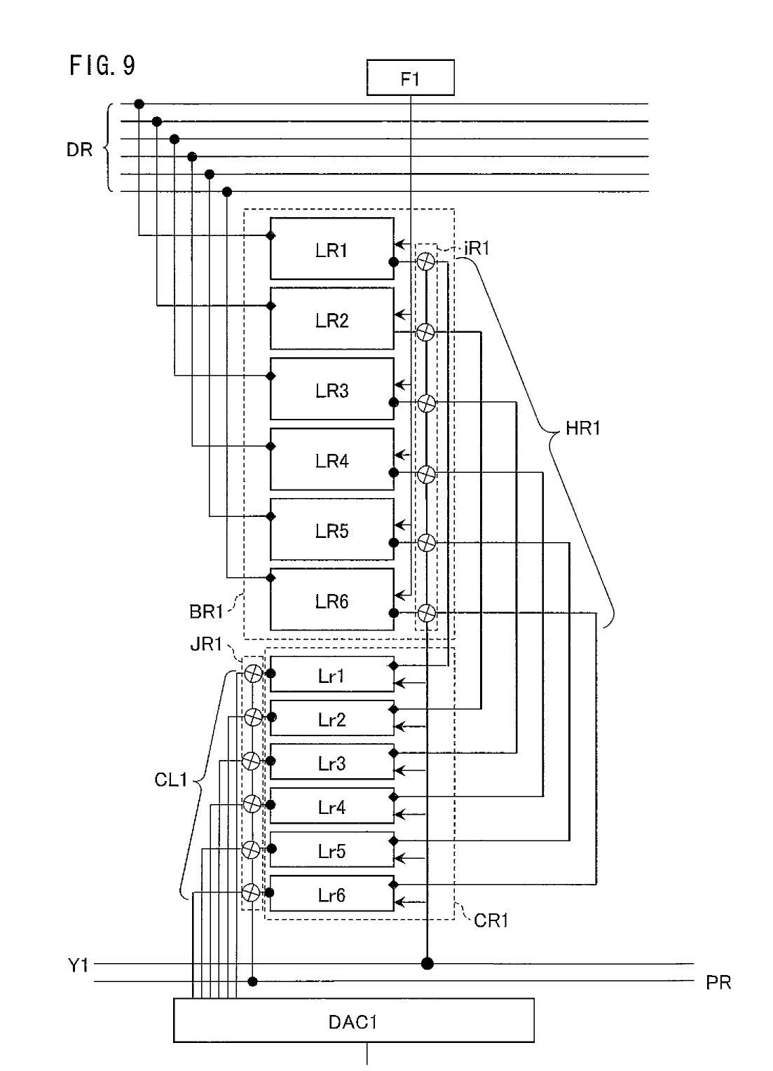

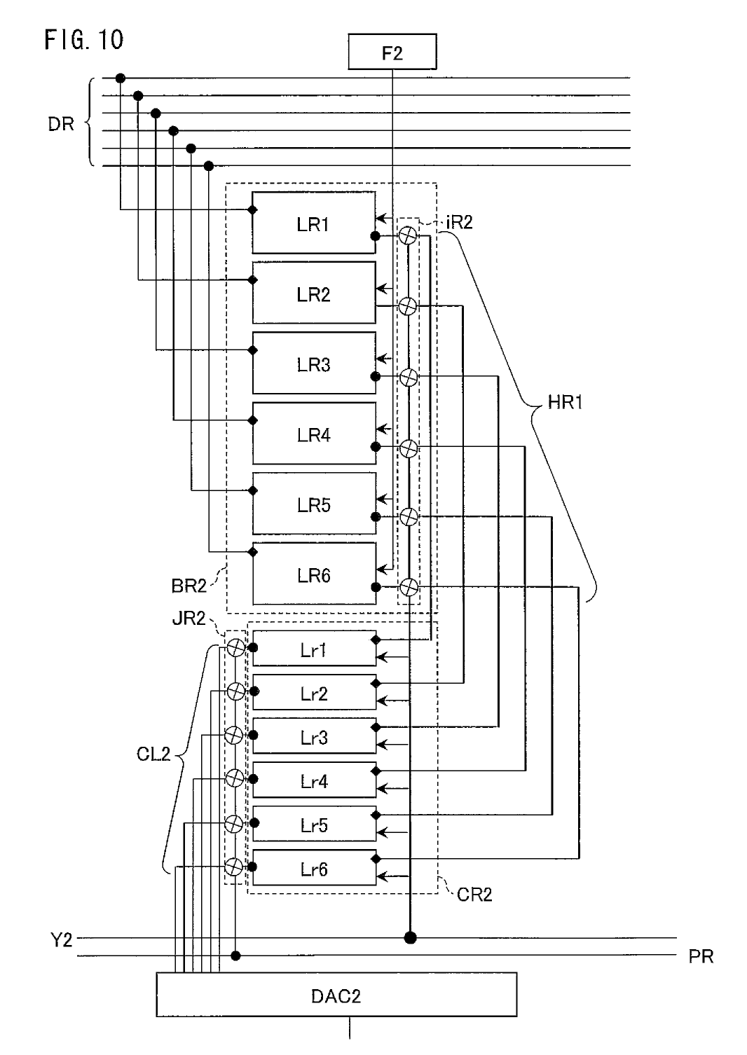

The transmission switching block T includes three switching circuits iR, iG, and iB. The switching circuit iR includes 6 switching elements to represent 6 bits for the discriminatingly-shared common wiring HR; The switching circuit iG includes 6 switching elements to represent 6 bits for the discriminatingly-shared common wiring HG; The switching circuit iB includes 6 switching elements to represent 6 bits for the discriminatingly-shared common wiring RB (see FIGS. 9 and 10). The transmission switching block T includes the switching elements to represent 18 bits in total. The selecting switch block K includes three switching circuits JR, JG, and JB. The switching circuit JR includes a 6-bit switching element corresponding to the downstream latch block CR; The switching circuit JG includes a 6-bit switching element corresponding to the downstream latch block CG; The switching circuit JB includes a 6-bit switching element corresponding to the downstream latch block CB (see FIGS. 9 and 10). The selecting switch block K includes the switching elements of 18 bits in total.

For example, a first signal processing block includes a flip-flop F1, a circuit block g1, a DAC1, and a time-division switch block W1. The first signal processing block corresponds to three data signal lines SR1, SG1, and SB1. The time-division switch block W1 includes three analog switches ER1, EG1, and EB1. The circuit block g1 includes: three upstream latch blocks: BR1, BG1, and BB1; three downstream latch blocks CR1, CG1, and CB1; a transmission switching block T1; a selecting switch block K1; and a universally-shared common wiring CL1. The transmission switching block T1 includes three switching circuits iR1, iG1, and iB1. The selecting switch block K1 includes three switching circuits JR1, JG1, and JB1. An inter-block common wiring Q1 is provided between the circuit block g1 and its adjacent circuit block g2. The inter-block common wiring Q1 includes discriminatingly-shared common wirings HR1, HG1, and HB1.

As illustrated in FIG. 7, each of the upstream latch blocks is connected to a corresponding flip-flop and to a corresponding input signal line. In addition, each of the upstream latch blocks is connected to a corresponding downstream latch block via a corresponding switching circuit and a corresponding discriminatingly-shared common wiring (6-bit). Each of the downstream latch blocks is connected to a corresponding DAC via a corresponding switching circuit and a universally-shared common wiring (6-bit). In addition, each of the downstream latch blocks is connected to the latch pulse line Y1 or Y2.

For example, the upstream latch block BR1 is connected to the flip-flop F1 and to the input signal line DR. In addition, the upstream latch block BR1 is connected to the downstream latch block CR1 via the switching circuit iR1 and the discriminatingly-shared common wiring HR1 (6-bit). The downstream latch block CR1 is connected to the DAC1 via the switching circuit JR1 and the universally-shared common wiring CL1 (6-bit). In addition, the downstream latch block CR1 is connected to the latch pulse line Y1. An upstream latch block BR2 is connected to a flip-flop F2 and to the input signal line DR. In addition, the upstream latch block BR2 is connected to an downstream latch block CR2 via a switching circuit iR2 and the discriminatingly-shared common wiring HR1 (6-bit). The downstream latch block CR2 is connected to a DAC2 via a switching circuit JR2 and a universally-shared common wiring CL2 (6-bit). In addition, the downstream latch block CR2 is connected to the latch pulse line Y2.

Each of the upstream latch blocks includes six first latch circuits aligned in the column direction. Similarly, each of the downstream latch blocks includes six second latch circuits aligned in the column direction. For example, as illustrated in FIG. 9, the upstream latch block BR1 includes first latch circuits LR1 through LR6. Similarly, the downstream latch block CR1 includes second latch circuits Lr1 through Lr6.

The following describes more concretely a relation of connection between the upstream latch block BR1 and the downstream latch block CR1, with reference to FIG. 9. All of the six first latch circuits LR1 through LR6 of the upstream latch block BR1 are connected to the flip-flop F1. Each of the first latch circuits LR1 through LR6 is connected to a corresponding wiring (a 1-bit wiring) of the input signal line DR (a 6-bit wiring). In addition, each of the first latch circuits LR1 through LR6 is connected to a corresponding second latch circuit in the downstream latch block CR1 via the switching circuit iR1 and one of the discriminatingly-shared common wiring HR1 (6-bit wirings). For example, the first latch circuit LR1 is connected to the second latch circuit Lr1 via the switching circuit iR1 and one (a 1-bit wiring) of the discriminatingly-shared common wiring HR1. Similarly, the first latch circuit LR6 is connected to the second latch circuit Lr6 via the switching circuit iR1 and one (a 1-bit wiring) of the discriminatingly-shared common wiring HR1. On the other hand, all of the second latch circuits Lr1 through Lr6 are connected to the latch pulse line Y1. In addition, all of the second latch circuits Lr1 through Lr6 are connected to the DAC1 via the corresponding switching circuit JR1 and one (a 1-bit wiring) of the universally-shared common wiring CL1. The latch pulse line Y1 is connected to the switching circuit iR1.

The following describes more concretely a relation of connection between the upstream latch block BR2 and the downstream latch block CR2, with reference to FIG. 10. All of six first latch circuits LR1 through LR6 of the upstream latch block BR2 are connected to the flip-flop F2. Each of the first latch circuits LR1 through LR6 is connected to a corresponding wiring (a 1-bit wiring) of the input signal line DR (a 6-bit wiring). In addition, each of the first latch circuits LR1 through LR6 is connected to a corresponding second latch circuit in the downstream latch block CR2 via the switching circuit iR2 and one of the discriminatingly-shared common wiring HR1 (a 6-bit wiring). For example, the first latch circuit LR1 is connected to the second latch circuit Lr1 via the switching circuit iR2 and one (a 1-bit wiring) of the discriminatingly-shared common wirings HR1. Similarly, the first latch circuit LR6 is connected to the second latch circuit Lr6 via the switching circuit iR2 and one (a 1-bit wiring) of the discriminatingly-shared common wirings HR1. On the other hand, all of second latch circuits Lr1 through Lr6 are connected to the latch pulse line Y2. In addition, all of the second latch circuits Lr1 through Lr6 are connected to the DAC2 via the corresponding switching circuit JR2 and one (a 1-bit wiring) of the universally-shared common wirings CL2. The latch pulse line Y2 is connected to the switching circuit iR2.

Accordingly, all of the downstream latch blocks in each odd-numbered circuit block are connected to the latch pulse line Y1 whereas all of the downstream latch blocks in each even-numbered circuit block are connected to the latch pulse line Y2. The transmission switching block T (including three switching circuits) in each odd-numbered circuit block is connected to the latch pulse line Y1 whereas the transmission switching block T (including three switching circuits) in each even-numbered circuit block is connected to the latch pulse line Y2.

With this arrangement, when the latch pulse line Y1 becomes active, the transmission switching block T in each odd-numbered circuit block becomes ON and latch pulses are supplied to the downstream latch blocks in the circuit block. This causes signals latched in the upstream latch blocks in each odd-numbered circuit blocks to be outputted to the downstream latch blocks via the inter-block common wirings Q. Similarly, when the latch pulse line Y2 becomes active, the transmission switching block T in each even-numbered circuit block becomes ON and latch pulses are supplied to the downstream latch blocks in the circuit block. This causes signals latched in the upstream latch blocks in each even-numbered circuit blocks to be outputted to the downstream latch blocks via the inter-block common wirings Q.

The three switching circuits JR, JG, and JB in each of the selecting switch blocks are connected to the corresponding switch control lines PR, PG, and PB, respectively. That is, the switching circuit JR1 in the selecting switch block K1 is connected to the switch control line PR; The switching circuit JG1 is connected to the switch control line PG; The switching circuit JB1 is connected to the switch control line PB.

Each DAC is connected to three data signal lines via a corresponding time-division switch block W. For example, the DAC1 is connected to the data signal lines SR1, SG1, and SB1 via the time-division switch block W1.

The three analog switches ER, EG, and EB in each of the time-division switch blocks W are connected to the corresponding switch control lines PR, PG, and PB, respectively. In addition, the three analog switches ER, EG, and EB are connected to the corresponding data signal lines SR, SG, and SB, respectively.

For example, the analog switch ER1 in the time-division switch block W1 is connected to the switch control line PR and also connected to the data signal line SR1; The analog switch EG1 is connected to the switch control line PG and also connected to the data signal line SG1; The analog switch EB1 is connected to the switch control line PB and also connected to the data signal line SB1.

Accordingly, for example, a signal of red (R) is processed by the upstream latch block BR connected to the input signal line DR, which is for red, the switching circuit iR, the distinctively-shared common wiring HR, the downstream latch block CR1, the switching circuit JR, the DAC, and the analog switch ER. The analog signal thus processed is outputted to the data signal line SR, which is of red. A signal of green (G) and a signal of blue (B) are also processed in the same way. Each DAC processes the signals of the three colors in a time-division manner.

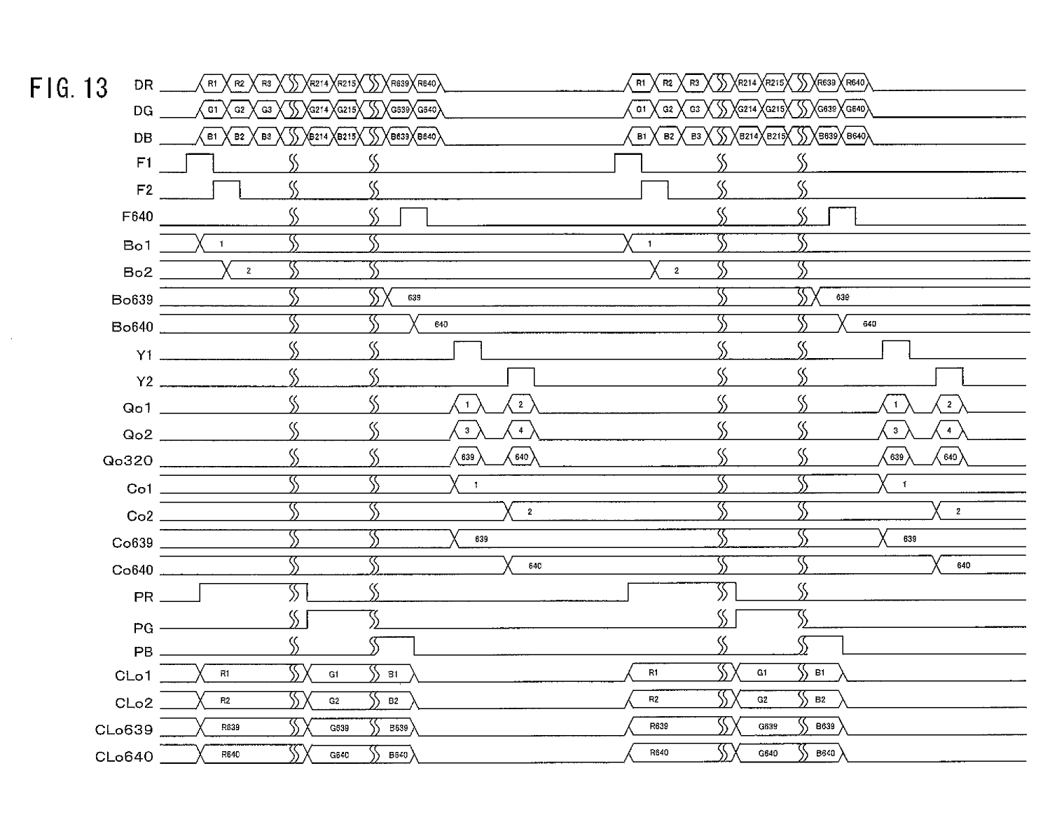

FIG. 13 is a timing diagram illustrating flows of signal processes of the digital driver 90. Each of R1 through R640 represents 6-bit input signal data corresponding to data signal lines SR1 through SR640, respectively; Each of G1 through G640 represents 6-bit input signal data corresponding to data signal lines SG1 through SG640, respectively; Each of B1 through B640 represents 6-bit input signal data corresponding to data signal lines SB1 through SB640, respectively. Bo represents an output signal of an upstream latch block; Co represents an output signal of a downstream latch block. Each of Qo1 through Qo320 represents a signal of an inter-block common wiring. Each of CLo1 through CLo640 represents a signals of a universally-shared common wiring.

At timing when an output pulse of the flip-flop F1 changes from Low to High (active), the upstream latch blocks BR1, BG1, and BB1 latch input signals R1, G1, and B1, respectively. Likewise, at timing when output pulses of flip-flops F2 through F640 sequentially change from High to Low, input signals (R2, G2, B2) through (R640, G640, B640) are sequentially latched, respectively.

After all of the input signals (R1, G1, B1) through (R640, G640, B640) are latched, an output pulse of the latch pulse line Y1 becomes High. This turns ON all of the transmission switching blocks connected to the latch pulse line Y1 (i.e., transmission switching blocks in odd-numbered circuit blocks). Accordingly, all of input signals (R1, G1, B1) through (R639, G639, B639) that are latched in the upstream latch blocks in the odd-numbered circuit blocks are outputted to corresponding downstream latch blocks via the inter-block common wirings Q (HR, HG, and HB). Then, an output pulse of the latch pulse line Y2 becomes High. This turns ON all of the transmission switching blocks connected to the latch pulse line Y2 (i.e., transmission switching blocks in even-numbered circuit blocks). Accordingly, all of input signals (R2, G2, B2) through (R640, G640, B640) that are latched in the upstream latch blocks in the even-numbered circuit blocks are outputted to corresponding downstream latch blocks via the inter-block common wirings Q (HR, HG, and HB).

Then, all of switching circuits (JR1 . . . ) connected to the switch control line PR are turned ON all together at timing when an output pulse of the switch control line PR becomes High. Accordingly, the input signals (R1 . . . ) are inputted into DAC (1 . . . ) via corresponding universally-shared common wirings (CL1 . . . ). As a result, the input signals R1 through R640 are converted into analog signal potentials Ra1 through Ra640, respectively. The switch control line PR is also connected to a corresponding analog switch. All of the analog switches (ER1 . . . ) connected to the switch control line PR are turned ON all together at timing when an output pulse of the switch control line PR becomes High. This supplies signal potentials Ra1 through Ra640 to corresponding data signal lines SR1 through SR640 via the analog switches being ON, respectively.

Then, all of switching circuits (JG1 . . . ) connected to the switch control line PG are turned ON all together at timing when an output pulse of the switch control line PG becomes High. Accordingly, the input signals (G1 . . . ) are inputted into DAC (1 . . . ) via corresponding universally-shared common wirings (CL1 . . . ). As a result, the input signals G1 through G640 are converted into analog signal potentials Gal through Ga640, respectively. The switch control line PG is also connected to a corresponding analog switch. All of the analog switches (EG1 . . . ) connected to the switch control line PG are turned ON all together at timing when an output pulse of the switch control line PG becomes High. This supplies signal potentials Gal through Ga640 to corresponding data signal lines SG1 through SG640 via the analog switches being ON, respectively.

Then, all of switching circuits (JB1 . . . ) connected to the switch control line PB are turned ON all together at timing when an output pulse of the switch control line PB becomes High. Accordingly, the input signals (B1 . . . ) are inputted into corresponding DAC (1 . . . ). As a result, the input signals B1 through B640 are converted into analog signal potentials Ba1 through Ba640, respectively. The switch control line PB is also connected to a corresponding analog switch. All of the analog switches (EB1 . . . ) connected to the switch control line PB are turned ON all together at timing when an output pulse of the switch control line PB becomes High. This supplies the signal potentials Ba1 through Ba640 to corresponding data signal lines SB1 through SB640 via the analog switches being ON, respectively.

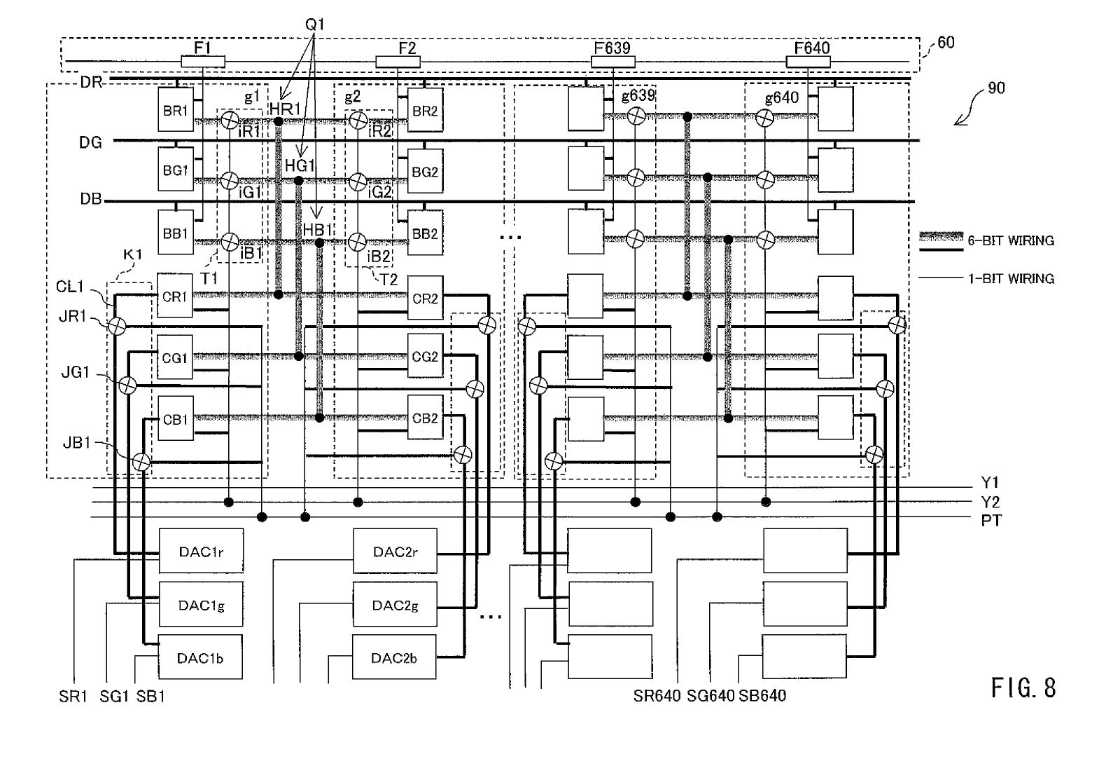

The digital driver 90 can be arranged as illustrated in FIG. 8. The arrangement is made based on the arrangement illustrated in FIG. 7 by removing therefrom the selecting switch block K, the time-division switch block W, and the three switch control lines PR, PG, and PB, and providing three DAC with each signal processing block. The rest is the same as the arrangement illustrated in FIG. 7.

In the arrangement illustrated in FIG. 8, each of the signal processing blocks includes one flip-flop F, one circuit block g, three DAC, and one time-division switch block W. Each of the signal processing blocks works for three data signal lines SR, SG, and SB of a display section.

The circuit blocks g includes three upstream latch blocks BR, BG, and BB, which are aligned in the column direction; three downstream latch blocks CR, CG, and CB, which are aligned in the column direction; and one transmission switching block T.

Each of the downstream latch blocks is connected to one data signal line via one DAC. For example, a downstream latch block CR1 is connected to a data signal line SR1 via a DAC1r; A downstream latch block CG1 is connected to a data signal line SG1 via a DAC1g; A downstream latch block CB1 is connected to a data signal line SB1 via a DAC1b.

Each of two adjacent circuit blocks (for example, g1 and g2) thus performs signal transmission in a time-division manner, via one inter-block common wiring (for example, Q1). This allows the number of wirings to be reduced. Moreover, signals are transmitted from a downstream latch block (for example, CR1) to a DAC via one universally-shared common wiring (for example, CL1) in a time-division manner. This also makes it possible to reduce the number of wirings between the downstream latch block and the DAC. This realizes miniaturization of a digital driver. Particularly, in a case where the digital driver is monolithically formed on a liquid crystal panel, a significant reduction effect of the size of the digital driver can be obtained through the reduction of the number of wirings.

The following describes a layout technique for an area between two adjacent circuit blocks with reference to FIGS. 1 and 7. FIG. 1 illustrates a layout of an area between two upstream circuits that are adjacent to each other in the row direction (i.e., one upstream circuit including BR1, BG1, and BB1, and the other upstream circuit including BR2, BG2, and BB2). The upstream latch block BR1 includes six first latch circuits LR1 through LR6; The upstream latch block BG1 includes six first latch circuits LR7 through LR12; The upstream latch block BB1 includes six first latch circuits LR13 through LR18. Accordingly, each upstream circuit includes 18 first latch circuits.

As illustrated in FIG. 1, 18 (6 bits×3) data wirings (DRa through DRf, DGa through DGf, and DBa through DBf) that compose input signal lines and are extended in the column direction are provided between two upstream circuits (i.e., between (BR1, BG1, BB1) and (BR2, BG2, BB2)) that are adjacent to each other in the row direction. In addition, 18 (6 bits×3) transmission wirings (HRa through HRf, HGa through HGf, and HBa through HBf) that compose inter-block common wirings and are extended in the column direction are provided between the two upstream circuits.

Any one of the 18 data wirings (DRa through DRf, DGa through DGf, and DBa through DBf) is extended to any one of the transmission wirings (HRa through HRf, HGa through HGf, and HBa through HBf). For example, the data wiring DRa is extended to the transmission wiring HRa; The data wiring DBf is extended to the transmission wiring HBf.

In the driver, each of high-potential-side power wirings VD and each of low-potential-side power wirings VS that are extended in the row direction are alternately provided. First latch circuits LR of the upstream latch block BR1 and those of the upstream latch block BR2 are provided between a high-potential-side power wiring and a low-potential-side power wiring, which are adjacent to each other, so that the longer sides of the first latch circuits LR are oriented in the row direction. Accordingly, power is supplied with a first latch circuit LR through the high-potential-side power wiring VD and the low-potential-side power wiring VS, which are respectively provided on the both sides of a first latch circuit LR.

Respective input terminals of two first latch circuits (LR1 of BR1 and LR1 of BR2) adjacent to each other in the row direction are connected to each other via an input wiring extended in the row direction. In addition, an output wiring extended in the row direction is provided between the two first latch circuits (LR1 of BR1 and LR1 of BR2).

Each of the 18 first latch circuits LR1 through LR18 of the upstream circuit is connected to one data wiring via the input wiring. Each of the first latch circuits LR1 through LR18 can be connected to one transmission wiring via the output wiring.

For example, the input terminal of the first latch circuit LR1 is connected to the data wiring DRa via an input wiring IL and the output terminal thereof can be connected to the transmission wiring HRa via an output wiring OL. The input terminal of the first latch circuit LR2 is connected to the data wiring DRb via an input wiring and the output terminal thereof can be connected to the transmission wiring HRb via an output wiring. The input terminal of the first latch circuit LR18 is connected to the data wiring DBf via an input wiring and the output terminal thereof can be connected to the transmission wiring HBf via an output wiring.

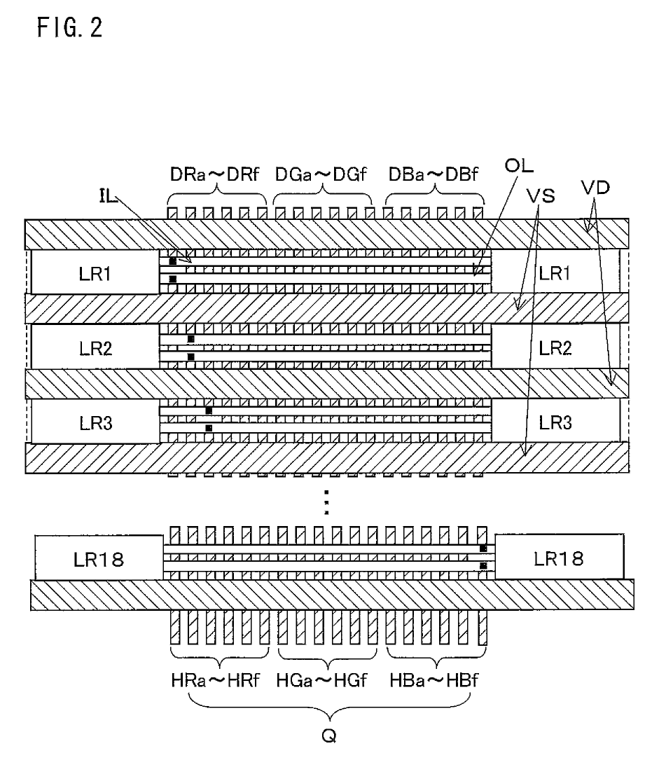

The digital driver illustrated in FIG. 1 can be modified as illustrated in FIG. 2. That is, one first latch circuit LR is provided between a high-potential-side power wiring VD and a low-potential-side power wiring VS that are adjacent to each other. Even-numbered first latch circuits are reversed to the orientation of odd-numbered first latch circuits. This makes it possible to reduce the number of the power wirings because one power wiring (VD or VS) can be shared between two first latch circuits. As a result, the area of the circuit of the driver can be reduced.

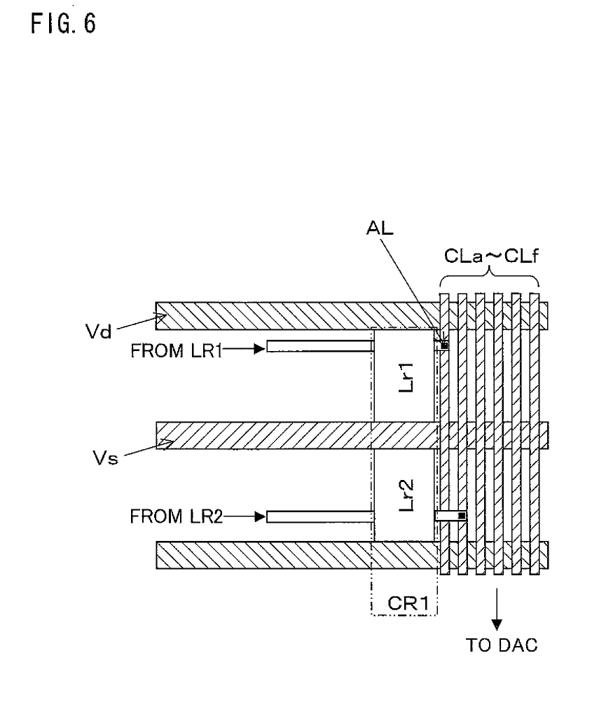

FIG. 6 illustrates one layout example of the downstream circuit (including the downstream latch blocks CR, CG, and CB). The downstream latch block CR includes six second latch circuits Lr1 through Lr6; The downstream latch block CG includes six second latch circuits Lr7 through Lr12; The downstream latch block CB includes six second latch circuits Lr13 through Lr18. Accordingly, each downstream circuit includes 18 second latch circuits.

As illustrated in FIG. 6, six relay wirings (CLa through CLf) that compose universally-shared common wiring CL are provided in the driver. In the driver, each of a plurality of high-potential-side power wirings Vd and each of a plurality of low-potential-side power wirings Vs that are extended in the row direction are alternately provided.

One second latch circuit Lr is provided between the high-potential-side power wiring Vd and the low-potential-side power wiring Vs, which are adjacent to each other, so that the longer side of the second latch circuit Lr is oriented in the row direction.

The six relay wirings (CLa through CLf), which compose the universally-shared common wiring, are extended along each downstream circuit (including the downstream latch blocks CR, CG, and CB) in the column direction. Each of the second latch circuits Lr1 through Lr6 in the downstream latch block CR can be connected respectively to any one of the relay wiring CLa through CLf; Each of the second latch circuits Lr1 through Lr6 in the downstream latch block CG can be connected respectively to any one of the relay wiring CLa through CLf; Each of the second latch circuits Lr1 through Lr6 in the downstream latch block CB can be connected respectively to any one of the relay wiring CLa through CLf.

For example, the second latch circuit Lr1 of the downstream latch block CR1 can be connected to the relay wiring CLa. Likewise, the second latch circuit Lr2 of the downstream latch block CR1 can be connected to the relay wiring CLb. For the connection between the second latch circuit Lr with the relay wiring, used is a wiring AL extended from the output terminal of the second latch circuit Lr in the row direction.

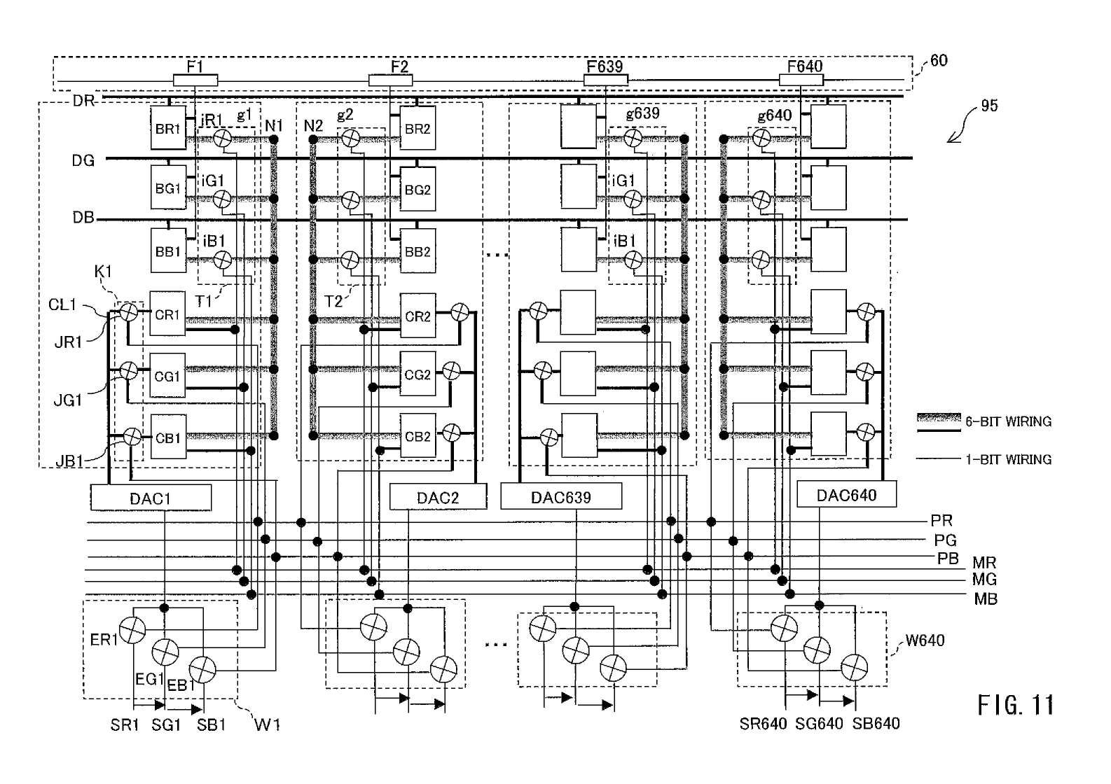

The digital driver can be arranged as illustrated in FIG. 11. As illustrated in FIG. 11, a digital driver 95 includes a plurality of signal processing blocks (not illustrated); three input signal lines DR, DG, and DB; three switch control lines PR, PG, and PB; and three (i.e., the number of video signals) transmission switching lines (control signal lines) MR, MG, and MB.

Each signal processing block includes one flip-flop F, one circuit block g, one DAC, and one time-division switch block W. Each signal processing block corresponds to three data signal lines SR, SG, and SB of a display section. Each time-division switch block W includes three analog switches ER, EG, and EB.

Each circuit block g includes three upstream latch blocks BR, BG, and BB, which are aligned in the column direction, three downstream latch blocks CR, CG, and CB, which are aligned in the column direction, one transmission switching block T, one in-block common wiring N, one selecting switch block K, and one universally-shared common wiring (6-bit) CL that is shared among signals.

In the digital driver 95, a plurality of circuit blocks is aligned in the column direction. The transmission switching block T includes three switching circuits iR, iG, and iB. The switching circuits iR, iG, and iB each include a 6-bit switching element corresponding to each of discriminatingly-shared common wirings HR, HG, and HB, respectively. Accordingly, the transmission switching block T includes switching elements of 18 bits in total. The selecting switch block K includes three switching circuits JR, JG and JB. The selecting switch circuits JR, JG, and JB each include a 6-bit switching element corresponding to each of the downstream latch blocks CR, CG, and CB, respectively. Accordingly, the selecting switch block K includes switching elements of 18 bits in total.

For example, a first signal processing block includes a flip-flop F1, a circuit block g1, a DAC1, and a time-division switch block W1. The first signal processing block corresponds to the three data signal lines SR1, SG1, and SB1. The time-division switch block W1 includes three analog switches ER1, EG1, and EB1. The circuit block g1 includes three upstream latch blocks BR1, BG1, and BB1, three downstream latch blocks CR1, CG1, and CB1, an in-block common wiring N1, a transmission switching block T1, a selecting switch block K1, and a universally-shared common wiring CL1 that is shared among signals. The transmission switching block T1 includes three switching circuits iR1, iG1, and iB1. The selecting switch block K1 includes three switching circuits JR1, JG1, and JB1.

As illustrated in FIG. 11, each upstream latch block is connected to a corresponding flip-flop and to a corresponding input signal line. Each upstream latch block is further connected to a corresponding downstream latch block via a corresponding switching circuit of a transmission switching block and an in-block common wiring (6-bit). Each downstream latch block is connected to the DAC via a corresponding switching circuit of a selecting switch block and a universally-shared common wiring (6-bit). Each downstream latch block is connected to the corresponding transmission switching line. Each transmission switching line is connected to the corresponding switching circuit of the transmission switching block.

For example, the upstream latch block BR1 is connected to the flip-flop F1 and to the input signal line DR. The upstream latch block BR1 is further connected to the downstream latch block CR1 via the switching circuit iR1 and the in-block common wiring N1 (6-bit). The downstream latch block CR1 is connected to the DAC1 via the switching circuit JR1 and the universally-shared common wiring CL1 (6-bit). The downstream latch block CR1 is also connected to the transmission switching line MR. The transmission switching line MR is connected to the switching circuit iR1 of the transmission switching block T1.

As described above, the downstream latch block CR is connected to the transmission switching line MR; The downstream latch block CG is connected to the transmission switching line MG; The downstream latch block CB is connected to the transmission switching line MB. The switching circuit iR of the transmission switching block is connected to the transmission switching line MR; The switching circuit iG is connected to the transmission switching line MG; The switching circuit iB is connected to the transmission switching line MB.

With the arrangement, when the transmission switching line MR becomes active, the switching circuit iR in the transmission switching block becomes ON and a latch pulse is supplied to the downstream latch block CR. This causes a signal latched in the upstream latch block BR to be outputted to the downstream latch block CR via the in-block common wiring N. Similarly, when the transmission switching line MG becomes active, the switching circuit iG in the transmission switching block becomes ON and a latch pulse is supplied to the downstream latch block CG. This causes a signal latched in the upstream latch block BG to be outputted to the downstream latch block CG via the in-block common wiring N. Similarly, when the transmission switching line MB becomes active, the switching circuit iB in the transmission switching block becomes ON and a latch pulse is supplied to the downstream latch block CB. This causes a signal latched in the upstream latch block BB to be outputted to the downstream latch block CB via the in-block common wiring N.

Each of three switching circuits in each selecting switch block is connected to the corresponding switch control line. That is, the switching circuit JR1 in the selecting switch block K1 is connected to the switch control line PR; the switching circuit JG1 is connected to the switch control line PG; the switching circuit JB1 is connected to the switch control line PB.

Each DAC is connected to three data signal lines via a corresponding time-division switch block. For example, the DAC1 is connected to the data signal lines SR1, SG1, and SB1 via the time-division switch block W1.

Each of three analog switches in a time-division switch block is connected to a corresponding switch control line and to a corresponding data signal line. For example, the analog switch ER1 of the time-division switch block W1 is connected to the switch control line PR and to the data signal line SR1; The analog switch EG1 is connected to the switch control line PG and to the data signal line SG1; The analog switch EB1 is connected to the switch control line PB and to the data signal line SB1.

A signal of red (R), for example, is processed by the upstream latch block BR1 connected to the input signal line DR of red, and the following members corresponding to the upstream latch block BR1: the switching circuit iR1, the in-block common wiring N1, the downstream latch block CR1, the switching circuit JR1, and the analog switch ER1. Signals of green (G) and blue (B) are also processed in the same way. The DAC1 processes the signals of the three colors in a time-division manner.

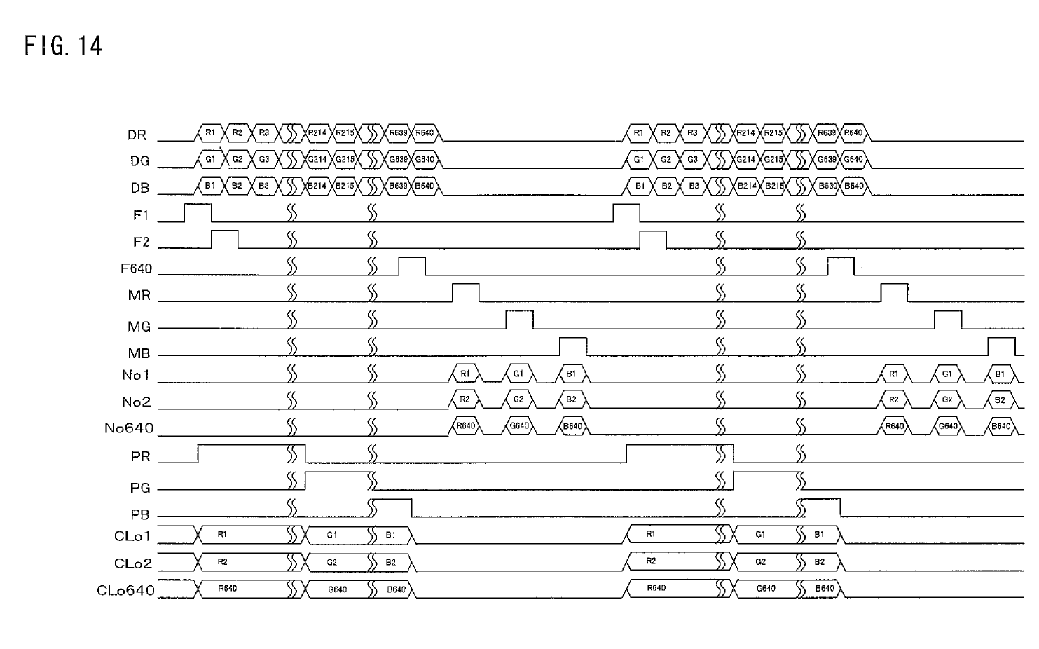

FIG. 14 is a timing diagram illustrating flows of signal processes of the digital driver 95. Each of R1 through R640 represents 6-bit input signal data corresponding to data signal lines SR1 through SR640, respectively; Each of G1 through G640 represents 6-bit input signal data corresponding to data signal lines SG1 through SG640, respectively; Each of B1 through B640 represents 6-bit input signal data corresponding to data signal lines SB1 through SB640, respectively. Not through No640 represent signals of the in-block common wirings. CLo1 through CLo640 represent signals of the universally-shared common wirings.

At timing when an output pulse of the flip-flop F1 changes from Low to High (active), the upstream latch blocks BR1, BG1, and BB1 latch input signals R1, G1, and B1, respectively. Likewise, at timing when output pulses of flip-flops F2 through F640 sequentially change from High to Low, input signals (R2, G2, B2) through (R640, G640, B640) are sequentially latched, respectively.

After all of the input signals (R1, G1, B1) through (R640, G640, B640) are latched, an output pulse of the transmission switching line MR becomes High. This turns ON all of the switching circuits iR connected to the transmission switching line MR. Accordingly, all of input signals R1 through R640 that are latched in the upstream latch block BR are outputted to the downstream latch block CR via the in-block common wiring N. Then, an output pulse of the transmission switching line MG becomes High. This turns ON all of the switching circuits iG connected to the transmission switching line MG. Accordingly, all of input signals (G1 through G640) that are latched in the upstream latch block GR are outputted to the downstream latch block CG via the in-block common wiring N. Then, an output pulse of the transmission switching line MB becomes High. This turns ON all of the switching circuits iB connected to the transmission switching line MB. Accordingly, all of input signals (G1 through G640) that are latched in the upstream latch block BG are outputted to the downstream latch block CB via the in-block common wiring N.

Then, all of the switching circuits (JR1 . . . ) connected to the switch control line PR are turned ON all together at timing when an output pulse of the switch control line PR becomes High. Accordingly, the input signals (R1 . . . ) are inputted into DAC (1 . . . ) via corresponding universally-shared common wirings (CL1 . . . ). As a result, input signals R1 through R640 are converted into analog signal potentials Ra1 through Ra640, respectively. The switch control line PR is also connected to a corresponding analog switch. All of the analog switches (ER1 . . . ) connected to the switch control line PR are turned ON all together at timing when an output pulse of the switch control line PB becomes High. This supplies signal potentials Ra1 through Ra640 to corresponding data signal lines SR1 through SR640 via the analog switches being ON.

All of the switch circuits (JG1 . . . ) connected to the switch control line PG are turned ON all together at timing when an output pulse of the switch control line PG becomes High. This supplies input signals (G1 . . . ) to the DAC (1 . . . ) via corresponding universally-shared common wirings (CL1 . . . ). As a result, the input signals G1 through G640 are converted into analog signal potentials Gal through Ga640. The switch control line PG is also connected to a corresponding analog switch. All of the analog switches (EG1 . . . ) connected to the switch control line PG are turned ON all together at timing when an output pulse of the switch control line PG becomes High. This supplies the signal potentials Gal through Ga640 to manner. This allows the number of wirings between the downstream latch block and the DAC to be reduced. This realizes miniaturization of a digital driver. Particularly, in a case where the digital driver is monolithically formed on a liquid crystal panel, a significant reduction effect of the size of the digital driver can be obtained through the reduction of the number of wirings.

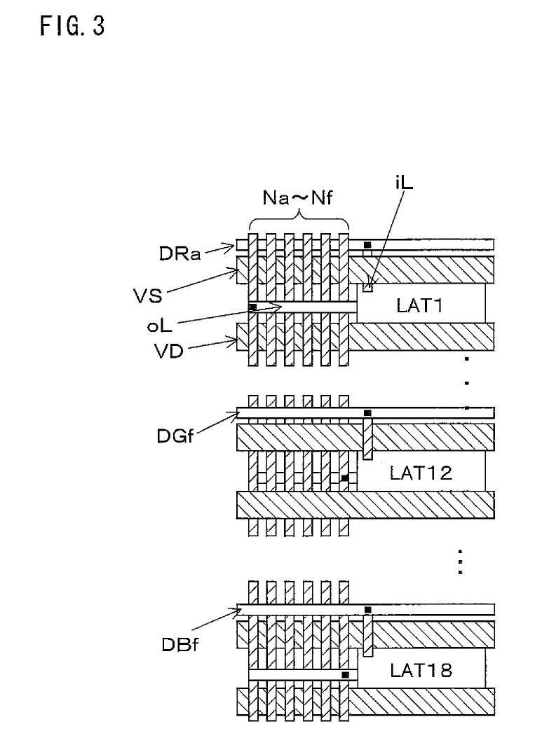

The following describes a concrete layout of the digital driver 95 with reference to FIGS. 3 and 11. FIG. 3 illustrates a layout of an upstream circuit (including three upstream latch blocks BR, BG, and BB). The upstream latch block BR includes six first latch circuits LR1 through LR6; The upstream latch block BG includes six first latch circuits LR7 through LR12; The upstream latch block BB includes six first latch circuits LR13 through LR18. Accordingly, the upstream circuit includes 18 first latch circuits.

As illustrated in FIG. 3, 18 (6 bits×3) data wirings (DRa through DRf, DGa through DGf, and DBa through DBf) that compose input signal lines and six transmission wirings (Na through Nf) that compose an in-block common wiring are provided in the driver. In the driver, each of a plurality of high-potential-side power wirings VD and each of a plurality of low-potential-side power wirings VS that are extended in the row direction are alternately provided.

One first latch circuit LR is provided between the high-potential-side power wiring VD and the low-potential-side power wiring VS, which are adjacent to each other, so that the longer side of the first latch circuit LR is oriented in the row direction. Each first latch circuit is provided with one data wiring extended in the row direction. That is, each upstream circuit is composed by aligning 18 sets each including the two power wirings (VD and VS), one first latch circuit, and one data wiring.

The six transmission wirings Na through Nf that compose the in-block common wiring are extended along the upstream circuits BR, BG, and BB in the column direction. Each of the first latch circuits LR1 through LR6 in the upstream latch block BR is connected respectively to any one of the data wirings DRa through DRf and can be connected to one of the transmission wirings Na through Nf; Each of the first latch circuits LR7 through LR12 in the upstream latch block BG is connected respectively to any one of the data wirings DGa through DGf and can be connected to one of the transmission wirings Na through Nf; Each of the first latch circuits LR13 through LR18 in the upstream latch block BB is connected respectively to any one of the data wirings DBa through DBf and can be connected to one of the transmission wirings Na through Nf.

For example, the first latch circuit LR1 is connected to the data wiring DRa and can be connected to the transmission wiring Na; The first latch circuit LR12 is connected to the data wiring DGf and can be connected to the transmission wiring Nf; The first latch circuit LR18 is connected to the data wiring DBf and can be connected to the transmission wiring Nf.

For the connection between the first latch circuit LR and the data wiring D, used is a wiring iL that is extended in the column direction from the input terminal of the first latch circuit LR; For the connection between the first latch circuit LR and the transmission wiring N, used is a wiring oL that is extended in the row direction from the output terminal of the first latch circuit LR.

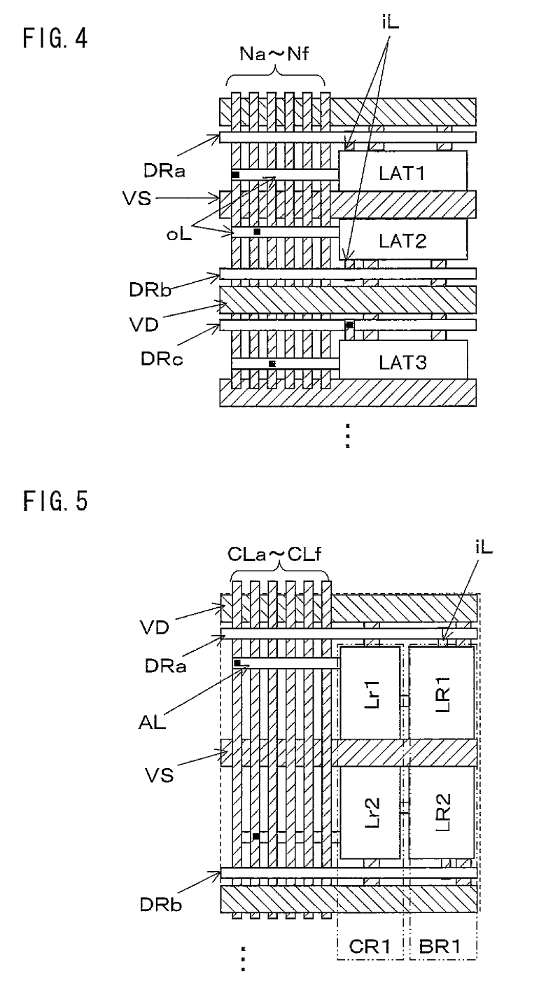

The digital driver illustrated in FIG. 3 can be modified as illustrated in FIG. 4. That is, one first latch circuit LR is provided between a high-potential-side power wiring VD and a low-potential-side power wiring VS that are adjacent to each other. Even-numbered first latch circuits are reversed to the orientation of odd-numbered first latch circuits. This allows the number of the power wirings to be reduced because one power wiring (VD or VS) can be shared between two first latch circuits. As a result, the area of the circuit of the driver can be reduced.

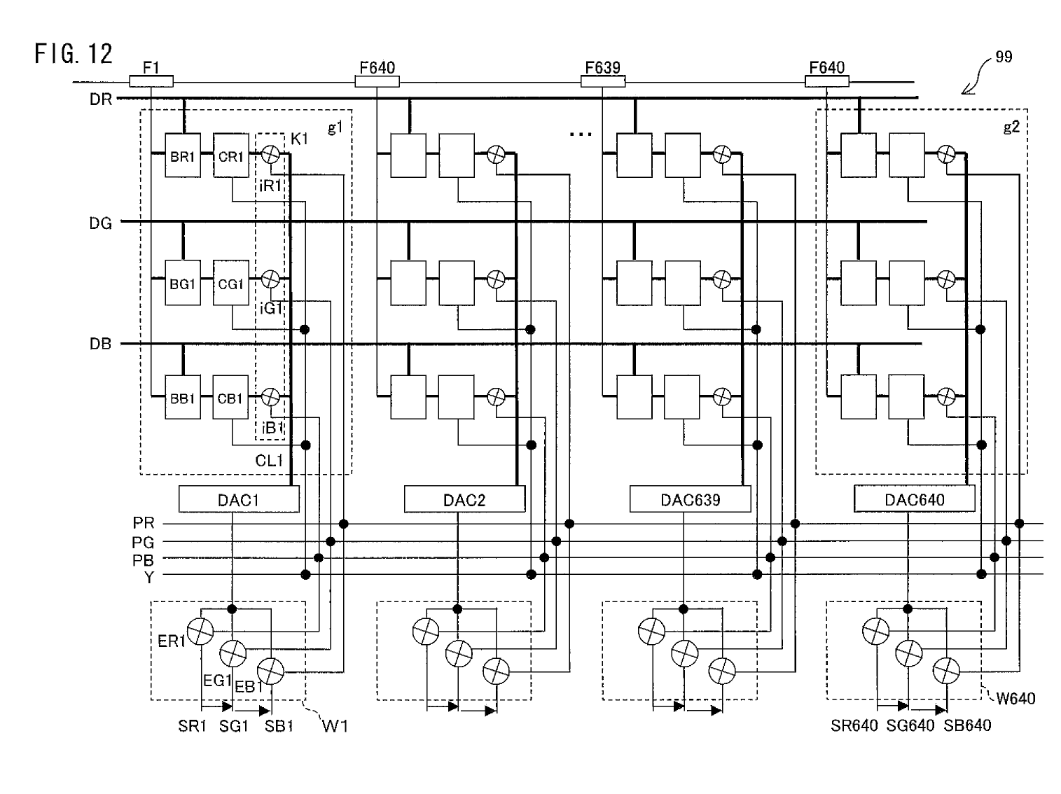

The digital driver can be arranged as illustrated in FIG. 12. As illustrated in FIG. 12, a digital driver 99 includes a plurality of signal processing blocks (not illustrated); three input signal lines DR, DG, and DR; three switch control lines PR, PG, and PB; and one latch pulse line Y.

Each signal processing block includes one flip-flop F, one circuit block g, one DAC, and one time-division switch block W. Each signal processing block corresponds to three data signal lines SR, SG, and SB of a display section. Each time-division switch block W includes three analog switches ER, EG, and EB.

Each circuit block g includes an upstream latch block BR and a downstream latch block CR that are adjacent to each other in the row direction; an upstream latch block BG and a downstream latch block CG that are adjacent to each other in the row direction; an upstream latch block BB and a downstream latch block CB that are adjacent to each other in the row direction; one selecting switch block K; and one universally-shared common wiring CL (6-bit) that is shared among signals. In the digital driver 99, a plurality of circuit blocks is aligned in the column direction. The selecting switch block K includes three switching circuits JR, JG, and JB. Each of the switching circuits JR, JG, and JB includes a 6-bit switching element corresponding to the downstream latch blocks CR, CG, and CB, respectively. Accordingly, the selecting switch block K includes 18 switching elements in total to represent 18 bits.

For example, the first signal processing block includes a flip-flop F1, a circuit block g1, a DAC1, and a time-division switch block W1. The first signal processing block corresponds to three data signal lines SR1, SG1, and SB1. The time-division switch block W1 includes three analog switches ER1, EG1, and EB1. The circuit block g1 includes an upstream latch block BR1 and a downstream latch block CR1 that are adjacent to each other in the row direction; an upstream latch block BG1 and a downstream latch block CG1 that are adjacent to each other in the row direction; an upstream latch block BB1 and a downstream latch block CB1 that are adjacent to each other in the row direction; a selecting switch block K1; and a universally-shared common wiring CL1. The selecting switch block K1 includes three switching circuits JR1, JG1, and JB1.

As illustrated in FIG. 12, each upstream latch block is connected to a corresponding flip-flop and to a corresponding input signal line. Each upstream latch block is further connected to an adjacent downstream latch block. Each downstream latch block is connected to the DAC via a corresponding switching circuit in a selecting switch block and a universally-shared common wiring (6-bit). Each downstream latch block is connected to the latch pulse line Y.

For example, the upstream latch block BR1 is connected to the flip-flop F1 and to the input signal line DR. The upstream latch block BR1 is further connected to the adjacent downstream latch block CR1. The downstream latch block CR1 is connected to the DAC1 via the switching circuit JR1 and the universally-shared common wiring CL1 (6-bit). The downstream latch block CR1 is also connected to the latch pulse line Y.

The three switching circuits in each selecting switch block are each connected to a corresponding switch control line. That is, the switching circuit JR1 in the selecting switch block K1 is connected to the switch control line PR; The switching circuit JG1 is connected to the switch control line PG; The switching circuit JB1 is connected to the switch control line PB.

Each DAC is connected to the three data signal lines via a corresponding time-division switch block. For example, the DAC1 is connected to the data signal lines SR1, SG1, and SB1 via the time-division switch block W1.

The three analog switches in each time-division switch block are each connected to a corresponding switch control line, and also connected to a corresponding data signal line. For example, the analog switch ER1 in the time-division switch block W1 is connected to the switch control line PR and to the data signal line SR1; The analog switch EG1 is connected to the switch control line PG and to the data signal line SG1; The analog switch EB1 is connected to the switch control line PB and to the data signal line SB1.

A signal of red (R), for example, is processed by the upstream latch block BR1 connected to the input signal line DR of red, and the following members corresponding to the upstream latch block BR1: the downstream latch block CR1, the switching circuit JR1, and the analog switch ER1. Signals of green (G) and blue (B) are also processed in the same way. The DAC1 processes the signals of the three colors in a time-division manner.

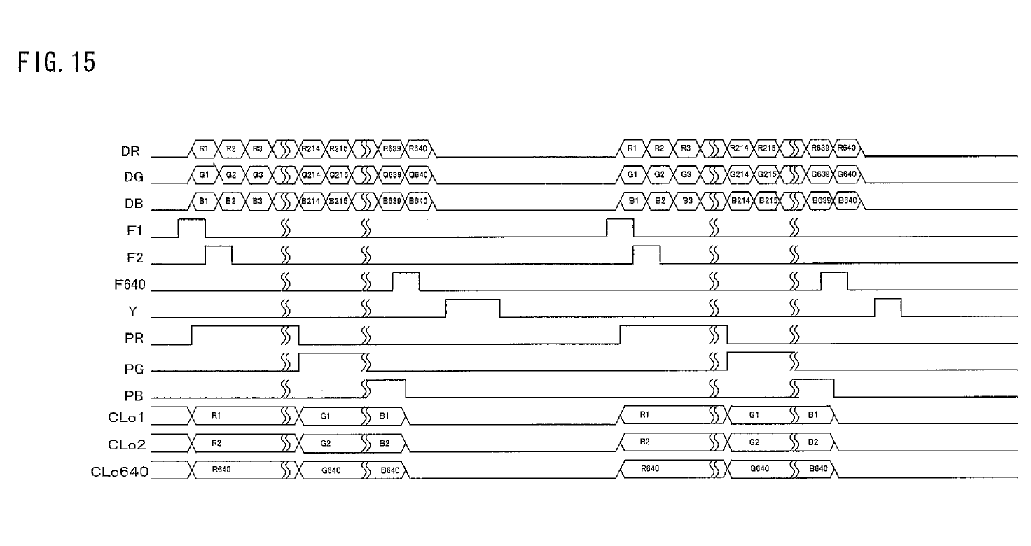

FIG. 15 is a timing diagram illustrating flows of signal processes of the digital driver 99. Each of R1 through R640 represents 6-bit input signal data corresponding to data signal lines SR1 through SR640, respectively; Each of G1 through G640 represents 6-bit input signal data corresponding to data signal lines SG1 through SG640, respectively; Each of B1 through B640 represents 6-bit input signal data corresponding to data signal lines SB1 through SB640, respectively. CLo1 through CLo640 represent signals of the universally-shared common wirings.

At timing when an output pulse of the flip-flop F1 changes from Low to High (active), the upstream latch blocks BR1, BG1, and BB1 latch input signals R1, G1, and B1, respectively. Likewise, at timing when output pulses of flip-flops F2 through F640 sequentially change from High to Low, input signals (R2, G2, B2) through (R640, G640, B640) are sequentially latched, respectively.

After all of the input signals (R1, G1, B1) through (R640, G640, B640) are latched, an output pulse of the latch pulse line Y becomes High. This causes all the input signals latched in the upstream latch blocks BR (R1 through R640) to be outputted to the downstream latch blocks CR. At the same time, all the input signals latched in the upstream latch blocks BG (G1 through G640) are outputted to the downstream latch blocks CG; All the input signals latched in the upstream latch blocks BB (B1 through B640) are outputted to the downstream latch blocks CB.

All of the switching circuits (JR1 . . . ) connected to the switch control line PR are turned ON all together at timing when an output pulse of the switch control line PR becomes High. Accordingly, the input signals (R1 . . . ) are inputted into DAC (1 . . . ) via corresponding universally-shared common wirings (CL1 . . . ). As a result, input signals R1 through R640 is converted into analog signal potentials Ra1 through Ra640. The switch control line PR is also connected to a corresponding analog switch. All of the analog switches (ER1 . . . ) connected to the switch control line PR are turned ON all together at timing when an output pulse of the switch control line PR becomes High. This causes signal potentials Hal through Ra640 to be supplied to corresponding data signal lines SR1 through SR640 via the analog switches being ON, respectively. The same holds true for cases where an output pulse of the switch control line PG becomes High and where an output pulse of the switch control line PB becomes High.

As described above, an upstream latch block B and a corresponding downstream latch block C are provided so as to be adjacent to each other and signal transmission is carried out from the downstream latch block C to a DAC via one universally-shared common wiring CL in a time-division manner. This realizes miniaturization of a digital driver.

The following describes a concrete layout of the digital driver 99 with reference to FIGS. 5 and 12. FIG. 5 illustrates a layout of the upstream circuit (including the three upstream latch blocks BR, BG, and BB) and the downstream circuit (including the downstream latch blocks BR, BG, and BB).

The upstream latch block BR includes six first latch circuits LR1 through LR6; The upstream latch block BG includes six first latch circuits LR7 through LR12; The upstream latch block BB includes six first latch circuits LR13 through LR18. Accordingly, the upstream circuit includes 18 first latch circuits. The downstream latch block CR includes six second latch circuits Lr1 through Lr6; The downstream latch block CG includes six second latch circuits Lr7 through Lr12; The downstream latch block CB includes six second latch circuits Lr13 through Lr18. Accordingly, the downstream circuit includes 18 second latch circuits.

As illustrated in FIG. 5, 18 (6 bits×3) data wirings (DRa through DRf, DGa through DGf, and DBa through DBf) that compose the input signal lines and six relay wirings (CLa through CLf) that compose the universally-shared common wiring CL are provided in the driver. In the driver, each of a plurality of high-potential-side power wirings VD and each of a plurality of low-potential-side power wirings VS that are extended in the row direction are provided alternately.

A first latch circuit LR is provided between a high-potential-side power wiring VD and a low-potential-side power wiring VS, which are adjacent to each other, so that the longer side of the first latch circuit LR is oriented in the column direction. The first latch circuit is connected to the high-potential-side power wiring VD and the low-potential-side power wiring VS. A second latch circuit Lr is provided so as to be adjacent to the first latch circuit LR, so that the longer side of the second latch circuit Lr is oriented in the column direction. The second latch circuit Lr is connected to the high-potential-side power wiring VD and the low-potential-side power wiring VS. In addition, one data wiring extended in the row direction is provided for the first latch circuit LR and the second latch circuit Lr.

The six relay wirings (CLa through CLf), which compose the universally-shared common wiring, are extended along each downstream circuit (including the downstream latch blocks CR, CG, and CB) in the column direction. Each of the first latch circuits Lr1 through Lr6 in the upstream latch block BR is connected respectively to any one of the data wirings DRa through DRf. Each of the second latch circuits Lr1 through Lr6 in the downstream latch block CR can be connected respectively to any one of the relay wirings CLa through CLf. Each of the first latch circuits Lr1 through Lr6 in the upstream latch block BG is connected respectively to any one of the data wirings DGa through DGf. Each of the second latch circuits Lr1 through Lr6 in the downstream latch block CG can be connected respectively to any one of the relay wirings CLa through CLf. Each of the first latch circuits Lr1 through Lr6 in the upstream latch block BB is connected respectively to any one of the data wirings DBa through DBf. Each of the second latch circuits Lr1 through Lr6 in the downstream latch block CS can be connected respectively to any one of the relay wirings CLa through CLf.

For example, the first latch circuit Lr1 in the upstream latch block BR1 is connected to the data wiring DRa. The second latch circuit Lr1 in the downstream latch block CR1 can be connected to the relay wiring CLa. The first latch circuit Lr2 in the upstream latch block BR1 is connected to the data wiring DRb. The second latch circuit Lr2 in the downstream latch block CR1 can be connected to the relay wiring CLb.

For the connection between the first latch circuit LR and the data wiring, used is a wiring iL extended from the input terminal of the first latch circuit LR in the column direction; For the connection between the second latch circuit Lr and the relay wiring, used is a wiring AL extended from the output terminal of the second latch circuit Lr in the row direction.

As illustrated in FIG. 5, moreover, a corresponding data signal lines SG1 through SG640 via the analog switches being ON, respectively.

All of the switch circuits (JB1 . . . ) connected to the switch control line PB are turned ON all together at timing when an output pulse of the switch control line PB becomes High. This supplies input signals (B1 . . . ) to corresponding DAC (1 . . . ). As a result, the input signals B1 through B640 are converted into analog signal potentials Ba1 through Ba640. The switch control line PB is also connected to a corresponding analog switch. All of the analog switches (EB1 . . . ) connected to the switch control line PB are turned ON all together at timing when an output pulse of the switch control line PB becomes High. This supplies the signal potentials Ba1 through Ba640 to corresponding data signal lines SB1 through SB640 via the analog switches being ON.

By use of an in-block common wiring (for example, the in-block common wiring N1), signal transmission from each upstream latch block to a corresponding downstream latch block (for example, BR1→CR1, BG1→CG1, BB1→CB1) is carried out in a time-division manner. This allows the number of wirings to be reduced. Moreover, signals are transmitted from a downstream latch block (for example, CR1) to a DAC via one universally-shared common wiring (for example, CL1) in a time-division longitudinally-oriented first latch circuit LR and a longitudinally-oriented second latch circuit Lr are provided, so as to be adjacent to each other in the row direction, between the high-potential-side power wiring VD and the low-potential-side power wiring VS, which are adjacent to each other. The first latch circuit LR and the second latch circuit Lr are connected to each other. This allows one power wiring (VD or VS) to be shared between two first latch circuits and between two second latch circuits. Accordingly, the number of power wirings can be greatly reduced. As a result, the area of the circuit of a driver can be reduced.

The invention being thus described, it will be obvious that the same way may be varied in many ways. Such variations are not to be regarded as a departure from the spirit and scope of the invention, and all such modifications as would be obvious to one skilled in the art are intended to be included within the scope of the following claims.

### INDUSTRIAL APPLICABILITY

A display panel driving circuit of the present invention is suitable for a source driver (especially, a digital driver) of a liquid crystal display apparatus etc.

1. A display panel driving circuit comprising a plurality of circuit blocks aligned in a row direction, each circuit block including an upstream circuit and a downstream circuit, wherein in each circuit block, a signal is transmitted from the upstream circuit to the downstream circuit,
wherein:
in each circuit block, the upstream circuit and the downstream circuit are aligned in a column direction;
between the circuit blocks adjacently paired, an inter-block common wiring that is connectable to the circuit blocks adjacently paired is provided; and
the signals from the circuit blocks adjacently paired are transmitted in a time-division manner via the inter-block common wiring.

2. The display panel driving circuit as set forth in claim 1, wherein:
the upstream circuit includes a plurality of upstream latch circuits aligned in the column direction;
the downstream circuit includes a plurality of downstream latch circuits respectively corresponding to the plurality of upstream latch circuits;
the inter-block common wiring includes a plurality of transmission wirings extended in the column direction; and
the upstream latch circuits, which belong respectively to the circuit blocks adjacently paired and are adjacently paired in the row direction, transmit the signal in the time-divisional manner via the same one of the plurality of transmission wirings.

3. The display panel driving circuit as set forth in claim 2, wherein:
an output wiring extended in the row direction is provided between the upstream latch circuits adjacently paired in the row direction,
the output wiring is connected to the transmission wiring and the transmission wiring is connectable, via the output wiring, with an output terminal of each of the upstream latch circuits adjacently paired in the row direction.

4. The display panel driving circuit as set forth in claim 2, wherein:
a plurality of data wirings extended in the column direction is provided between the circuit blocks adjacently paired; and
input terminals of the upstream latch circuits adjacently paired in the row direction are connected with each other via an input wiring extended in the row direction and the input wiring is connected with one of the plurality of data wirings.

5. The display panel driving circuit as set forth in claim 4, wherein:
the plurality of data wirings is provided as many as the plurality of transmission wirings and each of the plurality of transmission wirings is situated on a line extended from corresponding one of the plurality of data wirings.

6. The display panel driving circuit as set forth in claim 2, wherein:
each of the plurality of the upstream latch circuit is greater in size in the row direction than in the column direction.

7. The display panel driving circuit as set forth in claim 2, wherein:
high-potential-side power wirings extended in the row direction and low-potential-side power wirings extended in the row direction are provided alternately; and
each of the plurality of upstream latch circuits is provided respectively between the high-potential-side power wiring and the low-potential-side power wiring that are adjacent to each other.

8. The display panel driving circuit as set forth in claim 7, wherein:
in each of the circuit blocks, upstream latch circuits adjacently paired in the column direction are provided so that a structure of one of the upstream latch circuits and a structure of the other one of the upstream latch circuits are axisymmetrical with each other with respect to a line running in the row direction;
one high-potential-side power wiring is shared between the upstream latch circuits adjacently paired and one low-potential-side power wiring is shared between the two upstream latch circuits adjacently paired.

9. The display panel driving circuit as set forth in claim 2, wherein:
video data of one pixel of a display panel is transmitted from the upstream circuit to the downstream circuit; and
the plurality of transmission wirings is equal in number to a total number of bits of the video data of the one pixel.

10. A display panel driving circuit comprising a plurality of circuit blocks aligned in a row direction, each circuit block including a plurality of upstream signal circuits and a plurality of downstream signal circuits respectively corresponding to the plurality of upstream signal circuits, wherein in each circuit block, a signal is transmitted from each upstream signal circuit to the corresponding downstream signal circuit,
wherein:
in each of the plurality of circuit blocks, the plurality of upstream signal circuits are aligned in a column direction;
in each of the plurality of circuit blocks, an in-block common wiring is provided, to which all of the plurality of upstream signal circuits of the circuit block are connectable; and
the signal from each of the plurality of upstream signal circuits is transmitted in a time-division manner via the in-block common wiring.

11. The display panel driving circuit as set forth in claim 10, wherein:
each of the plurality of upstream signal circuits includes a plurality of upstream latch circuits aligned in the column direction;
each of the plurality of downstream signal circuits includes a plurality of downstream latch circuits respectively corresponding to the plurality of upstream latch circuits;
the in-block common wiring includes a plurality of transmission wirings extended in the column direction; and
each of the plurality of transmission wirings is connectable respectively to one of the plurality of upstream latch circuits included in each of the plurality of upstream signal circuits.

12. The display panel driving circuit as set forth in claim 11, wherein:
an output wiring extended in the row direction is provided for each of the plurality of upstream latch circuits; and
an output terminal of each of the plurality of upstream latch circuits is connectable to the corresponding one of the plurality of transmission wirings via the corresponding one of the plurality of output wirings.

13. The display panel driving circuit as set forth in claim 11, wherein:
a plurality of data wirings extended in the row direction is provided; and
each of the plurality of upstream latch circuits is connected respectively to one of the plurality of data wirings.

14. The display panel driving circuit as set forth in claim 11, wherein:
high-potential-side power wirings extended in the row direction and low-potential-side power wirings extended in the row direction are alternately provided; and
each of the plurality of upstream latch circuits is provided respectively between the high-potential-side power wiring and the low-potential-side power wiring that are adjacent to each other.

15. The display panel driving circuit as set forth in claim 14, wherein:
in each of the plurality of circuit blocks, upstream latch circuits adjacently paired in the column direction are provided so that a structure of one of the upstream latch circuits and a structure of the other one of the upstream latch circuits are axisymmetrical with each other with respect to a line running in the row direction;
one high-potential-side power wiring is shared between the upstream latch circuits adjacently paired; and
the low-potential-side power wiring is shared between the upstream latch circuits adjacently paired.

16. The display panel driving circuit as set forth in claim 11, wherein the upstream latch circuit is greater in size in the row direction than in the column direction.

17. The display panel driving circuit as set forth in claim 11, wherein:
video data of one sub-pixel of a display panel is transmitted from each upstream signal circuit to the corresponding downstream signal circuit; and
the plurality of transmission wirings is equal in number to a total number of bits of the video data of the one sub-pixel.

18. A display panel driving circuit comprising a plurality of circuit blocks aligned in a row direction, each circuit block including a plurality of upstream signal circuits, and a plurality of downstream signal circuits respectively corresponding to the plurality of upstream signal circuits, and one signal relay circuit, wherein a signal is transmitted from each downstream signal circuit to the signal relay circuit,
wherein:
in each of the plurality of circuit blocks, the plurality of downstream signal circuits is aligned in a column direction;
each of the plurality of circuit blocks includes a universally-shared common wiring to which all the downstream signal circuits of the circuit block are connectable; and
the signal from each of the plurality of downstream signal circuits is transmitted in a time-division manner via the universally-shared common wiring.

19. The display panel driving circuit as set forth in claim 18 wherein, in each of the plurality of circuit blocks, each upstream signal circuit and the corresponding downstream signal are aligned adjacently to each other in the row direction and connected to each other.

20. The display panel driving circuit as set forth in claim 19, wherein:
each of the plurality of upstream signal circuits includes a plurality of upstream latch circuits aligned in the column direction;
each of the plurality of downstream signal circuits includes a plurality of downstream latch circuits respectively corresponding to the plurality of upstream latch circuits;
the universally-shared common wiring includes a plurality of relay wirings extended in the column direction; and
each of the plurality of relay wirings is connectable respectively to one of the plurality of downstream latch circuits included in each of the plurality of downstream signal circuits.

21. The display panel driving circuit as set forth in claim 20, wherein:
an output wiring extended in the row direction is provided for each of the plurality of downstream latch circuits; and
an output terminal of each of the plurality of downstream latch circuits is connectable to the corresponding one of the plurality of relay wirings via the corresponding one of the plurality of output wirings.

22. The display panel driving circuit as set forth in claim 20, wherein:
a plurality of data wirings extended in the row direction is provided; and
each of the plurality of upstream latch circuits is respectively connected to one of the plurality of data wirings.

23. The display panel driving circuit as set forth in claim 20, wherein:
high-potential-side power wirings extended in the row direction and low-potential-side power wirings extended in the row direction are alternately provided;
each upstream latch circuit and the corresponding downstream latch circuit are aligned adjacently to each other in the row direction and connected to each other; and
each upstream latch circuit and the corresponding downstream latch circuit are provided respectively between the high-potential-side power wiring and the low-potential-side power wiring that are adjacent to each other.

24. The display panel driving circuit as set forth in claim 20, wherein each of the plurality of upstream latch circuits and each of the plurality of downstream latch circuits are greater in size in the column direction than in the row direction.

25. A display panel driving circuit comprising a plurality of circuit blocks aligned in a row direction, each circuit block including an upstream circuit and a downstream circuit, wherein signal transmission is carried out between the upstream circuit and the downstream circuit that belong to the same circuit block, wherein:
in each of the plurality of circuit blocks, a plurality of upstream circuits and a plurality of downstream circuits are aligned in a column direction;
an inter-block common wiring is provided for every two circuit blocks; and
signal transmission in one of the two circuit blocks and signal transmission in the other of the two circuit blocks are carried out via the inter-block common wiring at respective timings that are different from each other.

26. A display apparatus comprising:
a display panel driving circuit as set forth in any one of claims 1, 10, 18 and 25; and
a display panel driven by the display panel driving circuit.

27. The display apparatus as set forth in claim 26, wherein the display panel and the display panel driving circuit are monolithically formed.
